(19) United States
(12) Patent Application Publication
(10) Pub. No.: US 2025/0161879 A1
(43) Pub. Date: May 22, 2025

(54) PROCESS AND PRODUCT

(71) Applicant: Geo40 Limited, Taupo (NZ)

(72) Inventors: Campbell McNicoll, Taupo (NZ); Michael T. O'Sullivan, Turangi (NZ); Isabela Alvares de Castro, Taupo (NZ); William B. Bourcier, Livermore, CA (US)

(73) Assignee: Geo40 Limited, Taupo (NZ)

(21) Appl. No.: 18/949,693

(22) Filed: Nov. 15, 2024

(30) Foreign Application Priority Data
Nov. 17, 2023 (AU) 2023903699
Apr. 5, 2024 (AU) 2024900946

(51) Int. Cl. B01D 61/14; B01D 15/16; B01D 15/20; B01D 61/02; B01D 61/24; B01D 61/58; B01J 39/02; B01J 39/10; B01J 47/011; C22B 3/24; C22B 26/12

(52) U.S. Cl. CPC B01D 61/145; B01D 15/166; B01D 15/203; B01D 61/027; B01D 61/243; B01D 61/58; B01J 39/02; B01J 39/10; B01J 47/011; C22B 3/24; C22B 26/12; B01D 2315/10

(57) ABSTRACT

A process for mechanical separation of sorbent particles in a Direct Lithium Extraction (DLE) process using an ultrafiltration membrane and/or nanofiltration membrane. Also disclosed is a system for mechanical separation of sorbent particles in a Direct Lithium Extraction (DLE) process using an ultrafiltration membrane and/or nanofiltration membrane. Also disclosed is an improved DLE process with a pH controlled upload step.

### TECHNICAL FIELD

This disclosure relates to a Direct Lithium Extraction (DLE) process. More particularly, this disclosure relates to a DLE process using a lithium sorbent and an ultrafiltration membrane or nanofiltration membrane as the filtration system. This disclosure also describes an improved DLE process with a pH controlled upload step.

### BACKGROUND ART

Lithium is present naturally in many rocks (such as pegmatites), ocean water, brines, mineral springs and ground waters. Lithium solutions can also be a side product from lithium processing facilities, battery recycling plants, oil well brines, formation waters or other waste or process streams. However, these sources may only contain low concentrations of lithium, for example sea water contains less than 1 ppm of lithium, or specific impurities that make the incumbent processes for extracting lithium, such as evaporation, not viable. Therefore, to be extracted for use, the lithium must be concentrated and/or converted into a useful chemical form.

Lithium has many uses, but one of the most dominant is the manufacture of batteries, which has high demand due to the growing use of electronics, electric vehicles and storage of renewable energy such as solar power.

Lithium can be extracted from solution (for example brines) using a sorbent. For example, JPS61247618A describes a method for recovering lithium from geothermal hot water using a manganese dioxide sorbent.

U.S. Pat. No. 4,665,049 describes a method for preparation of an absorbent for lithium in an aqueous medium.

JPS61171535A describes a lithium absorbent, a method for producing the same, and a method for recovering lithium from a dilute solution using the same.

However, in order to extract lithium from sources with low concentrations of lithium and/or in order to make the process more commercially useful, the sorbent needs to have a high capacity to absorb lithium ions and fast absorption kinetics.

Therefore, the sorbent's specific surface area is an important parameter in relation to lithium absorption capacity and kinetics in a DLE process, with increased surface area in contact with the lithium solution being favourable.

For example, the lithium ions are absorbed by the sorbent in the DLE process, leaving behind a lithium depleted fluid. The process of separating the loaded sorbent and the fluid (solid and liquid phases) during the DLE process can involve one or more mechanical separation methods, for example: sedimentation, centrifugation, separation, sieving and filtration.

In general the particle size of the solid has a significant effect on solid/liquid separation.

For example, a micronized sorbent has an average particle size less than 1,000 microns, or typically, less than 100 microns.

Common filtration methods can be very difficult using standard equipment e.g. filter presses, candle filters, drum filters or vacuum filters. This is due to the presence of micronized particles, leading to the blockage of the filter pores and poor filter cake porosity. Furthermore, the filterability of metal oxide lithium sorbents can continue to decrease as cycling of the sorbent broadens the particle size distribution. This is due to the chemical and mechanical degradation of the sorbent particles. Furthermore, the use of centrifuge separation can also be difficult, with the presence of ultra fine particles requiring extremely high gravitational force. This makes centrifuges prohibitively expensive and cyclones inefficient.

In this specification, where reference has been made to external sources of information, including patent specifications and other documents, this is generally for the purpose of providing a context for discussing the features of the present invention. Unless stated otherwise, reference to such sources of information is not to be construed, in any jurisdiction, as an admission that such sources of information are prior art or form part of the common general knowledge in the art.

It is an object of this disclosure to provide a process for lithium manganese sorbent separation using ultrafiltration which goes at least some way towards overcoming one or more of the abovementioned problems or difficulties, and/or to at least provide the industry/public with a useful choice.

### SUMMARY OF THE INVENTION

In a first aspect, the present invention provides a process for extracting lithium from an aqueous solution containing lithium, the process comprising:
(i) contacting an aqueous solution containing lithium with a lithium sorbent to absorb the lithium to produce a mixture of a lithium loaded sorbent and lithium depleted solution,
(ii) separating the lithium loaded sorbent and the lithium depleted solution,
(iii) treating the lithium loaded sorbent to produce a mixture of a lithium rich solution and a regenerated sorbent, and
(iv) separating the lithium rich solution and the regenerated sorbent, wherein the pH in step (i) is controlled to provide the lithium depleted solution at a pH of about 3 to 7.

In a second aspect, the invention provides a process for extracting lithium from an aqueous solution containing lithium, the process comprising:
(i) contacting an aqueous solution containing lithium with a lithium sorbent to absorb the lithium to produce a mixture of a lithium loaded sorbent and lithium depleted solution,
(ii) separating the lithium loaded sorbent and the lithium depleted solution,
(iii) treating the lithium loaded sorbent to produce a mixture of a lithium rich solution and a regenerated sorbent, and
(iv) separating the lithium rich solution and the regenerated sorbent, wherein the separating step (ii) and/or the separating step (iv) comprises the use of an ultrafiltration membrane or a nanofiltration membrane.

In a third aspect, the invention provides a process for extracting lithium from an aqueous solution containing lithium, the process comprising:
(i) contacting an aqueous solution containing lithium with a lithium sorbent to absorb the lithium to produce a mixture of a lithium loaded sorbent and lithium depleted solution,
(ii) separating the lithium loaded sorbent and the lithium depleted solution,
(iii) treating the lithium loaded sorbent to produce a mixture of a lithium rich solution and a regenerated sorbent, and
(iv) separating the lithium rich solution and the regenerated sorbent, wherein the pH in step (i) is controlled to provide the lithium depleted solution at a pH of about 3 to 7 and the separating step (ii) and/or the separating step (iv) comprises the use of an ultrafiltration membrane and/or a nanofiltration membrane.

In a fourth aspect, the invention provides a process for extracting lithium from an aqueous solution containing lithium, the process comprising:
(i) contacting an aqueous solution containing lithium with a lithium sorbent to absorb the lithium to produce a mixture of a lithium loaded sorbent and lithium depleted solution,
(ii) separating the lithium loaded sorbent and the lithium depleted solution,
(iii) treating the lithium loaded sorbent with an acid to produce a mixture of a lithium rich solution and a regenerated sorbent, and
(iv) separating the lithium rich solution and the regenerated sorbent, wherein the pH in step (i) is controlled to provide the lithium depleted solution at a pH of about 3 to 5.5.

In a fifth aspect, the invention provides a system for extracting lithium from an aqueous solution containing lithium, the system comprising:
(i) a first container for contacting an aqueous solution containing lithium with a lithium sorbent to absorb the lithium to produce a mixture of a lithium loaded sorbent and lithium depleted solution,
(ii) a first separating device to separate the lithium loaded sorbent and the lithium depleted solution,
(iii) means for treating the lithium loaded sorbent to produce a mixture of a lithium rich solution and a regenerated sorbent, and
(iv) a second separating device to separate the lithium rich solution and the regenerated sorbent wherein the first separating device and/or the second separating device comprises an ultrafiltration membrane and/or a nanofiltration membrane.

In a sixth aspect, the invention provides a system for extracting lithium from an aqueous solution containing lithium, the system comprising,
(i) a first container for contacting an aqueous solution containing lithium with a lithium sorbent to absorb the lithium to produce a lithium loaded sorbent and lithium depleted solution,
(ii) pH control to control the pH of the aqueous solution to provide the lithium depleted solution at a pH of about 3 to 7,
(iii) a pH monitor to measure the pH of the aqueous solution containing lithium and/or the lithium depleted solution,
(iv) a first separating device to separate the lithium loaded sorbent and the lithium depleted solution,
(v) means for treating the lithium loaded sorbent to produce a lithium rich solution and a regenerated sorbent, and
(vi) a second separating device to separate the lithium rich solution and the regenerated sorbent.

In a seventh aspect, the invention provides a system for extracting lithium from an aqueous solution containing lithium, the system comprising,
(i) a first container for contacting an aqueous solution containing lithium with a lithium sorbent to absorb the lithium to produce a mixture of a lithium loaded sorbent and lithium depleted solution,
(ii) pH control to control the pH of the aqueous solution to provide the lithium depleted solution at a pH of about 3 to 7,
(iii) a pH monitor to measure the pH of the aqueous solution containing lithium and/or the lithium depleted solution,
(iv) a first separating device to separate the lithium loaded sorbent and the lithium depleted solution,
(v) means for treating the lithium loaded sorbent to produce a mixture of a lithium rich solution and a regenerated sorbent, and
(vi) a second separating device to separate the lithium rich solution and the regenerated sorbent.
wherein the first separating device and/or the second separating device comprises an ultrafiltration membrane and/or a nanofiltration membrane.

The following embodiments refer to any one or more of the above aspects.

The following embodiments and preferences may relate alone or in any combination of any two or more to any of the above aspects.

In some embodiments, the lithium sorbent is a metal oxide-based ion exchange sorbent. In some embodiments, the metal oxide-based ion exchange sorbent is a hydrogen manganese oxide sorbent or hydrogen titanium oxide sorbent. In some embodiments, the metal oxide-based ion exchange sorbent is a hydrogen manganese oxide sorbent.

In some embodiments, the lithium sorbent is micronized.

In some embodiments, the lithium sorbent has an average particle size D₅₀ of less than about 100 μm. In some embodiments, the lithium sorbent has an average particle size D₅₀ of less than about 50 μm, less than about 40 μm, less than about 30 μm, less than about 20 μm, less than about 10 μm, less than about 8 μm, less than about 6 μm, less than about 4 μm or less than about 2 μm.

In some embodiments, the lithium sorbent has a particle size distribution of about 100 to 0.01 μm. In some embodiments, the lithium sorbent has a particle size distribution of about 50 to 0.01 μm, about 20 to 0.01 μm, about 10 to 0.01 μm, about 5 to 0.01 μm or about 2 to 0.1 μm.

In some embodiments, the lithium sorbent has a particle size distribution of about 100 to 0.1 μm. In some embodiments, the lithium sorbent has a particle size distribution of about 50 to 0.1 μm, about 20 to 0.1 μm or about 10 to 0.1 μm.

In some embodiments, the lithium sorbent has a density of about 1.8 to 5.0 g/cm³.

In some embodiments, a base is added to the aqueous solution containing lithium to maintain the pH between 3 to 7 when the lithium is being absorbed.

In some embodiments, the aqueous solution comprises a buffer to maintain the pH between 3 to 7 when the lithium is being absorbed.

In some embodiments, the pH of the aqueous solution containing lithium is maintained at an average pH of about 3 to 7 when the lithium is being absorbed. In some embodiments, the pH of the aqueous solution containing lithium is maintained at an average pH of about 5 to 7 when the lithium is being absorbed. In some embodiments, the pH of the aqueous solution containing lithium is maintained at an average pH of about 5 to 6 when the lithium is being absorbed.

In some embodiments, the pH of the aqueous solution containing lithium is maintained at an average pH of about 6 to 7 during step (i) and allowed to become more acidic at the end of step (i).

In some embodiments, the pH of the aqueous solution containing lithium is maintained at an average pH of about 6 to 7 during step (i) and allowed to reach a pH of about 5 at the end of step (i).

In some embodiments, the pH of the aqueous solution containing lithium is maintained at an average pH of about 6 to 7 during step (i) and acidified to a pH of about 5 at the end of step (i).

In some embodiments, the base is added at a rate such that localized precipitation is reduced. In some embodiments, the base is added at a rate such that the pH is maintained between 3 to 7.

In some embodiments, the base is added at a rate such that localized precipitation substantially does not occur. In some embodiments, the base is added at a rate such that the pH does not exceed pH 7. In some embodiments, the base is added at a rate such that localized precipitation substantially does not occur. In some embodiments, the base is added at a rate such that the pH does not exceed pH 6.99. In some embodiments, the base is added at a rate such that localized precipitation substantially does not occur. In some embodiments, the base is added at a rate such that the pH does not exceed pH 5.5.

In some embodiments, a diluted base is added to the aqueous solution containing lithium such that localized precipitation is reduced.

In some embodiments, a diluted base is added to the aqueous solution containing lithium such that localized precipitation substantially does not occur.

In some embodiments, the pH in step (i) is controlled to provide the lithium depleted solution at a pH of about 3 to 5.5.

In some embodiments, the lithium depleted solution has a pH of about 3.0 to 6.9 once absorption is substantially completed. In some embodiments, the lithium depleted solution has a pH of about 3.0 to 6.0 once absorption is substantially completed. In some embodiments, the lithium depleted solution has a pH of about 3.0 to 5.8 once absorption is substantially completed. In some embodiments, the lithium depleted solution has a pH of about 3.0 to 5.5 once absorption is substantially completed.

In some embodiments, the separating step (ii) and/or the separating step (iv) comprises the use of an ultrafiltration membrane. In some embodiments, the separating step (ii) and/or the separating step (iv) comprises the use of a nanofiltration membrane.

In some embodiments, the separating step (ii) and/or the separating step (iv) comprises filtering the mixture through an ultrafiltration membrane and/or a nanofiltration membrane.

In some embodiments, the separating step (ii) and/or the separating step (iv) comprises dewatering the mixture with an ultrafiltration membrane and/or a nanofiltration membrane.

In some embodiments, the separating step (ii) and the separating step (iv) comprises filtering the solution through an ultrafiltration membrane and/or a nanofiltration membrane. In some embodiments, the separating step (ii) comprises filtering the solution through an ultrafiltration membrane and/or a nanofiltration membrane to separate the lithium loaded sorbent and the lithium depleted solution. In some embodiments, the separating step (iv) comprises filtering the solution through an ultrafiltration membrane and/or a nanofiltration membrane to separate the lithium rich solution and the regenerated sorbent.

In some embodiments, the separating step (ii) and/or separating step (iv) comprises a dialysis step, wherein the sorbent is washed with water and filtered through an ultrafiltration membrane and/or a nanofiltration membrane to decrease the amount of a soluble impurity in the sorbent. In some embodiments, the separating step (ii) and/or separating step (iv) comprises a dialysis step, wherein the sorbent is washed with water and filtered through an ultrafiltration membrane and/or nanofiltration membrane to substantially decrease the amount of a soluble impurity in the sorbent. In some embodiments, the separating step (ii) and separating step (iv) comprise a dialysis step, wherein the sorbent is washed with water and filtered through an ultrafiltration membrane and/or nanofiltration membrane to decrease the amount of a soluble impurity in the sorbent. In some embodiments, the separating step (ii) comprises a dialysis step, wherein the lithium loaded sorbent is washed with water and filtered through an ultrafiltration membrane and/or nanofiltration membrane to decrease the amount of a soluble impurity in the sorbent. In some embodiments, the separating step (iv) comprises a dialysis step, wherein the regenerated sorbent is washed with water and filtered through an ultrafiltration membrane and/or nanofiltration membrane to decrease the amount of a soluble impurity in the sorbent. In some embodiments, the water is deionized water. In some embodiments, the dialysis step reduces the conductivity of a filtrate. In some embodiments, the conductivity of the filtrate after the dialysis step is less than about 100 mS/cm, less than about 50 mS/cm, less than about 40 mS/cm, less than about 30 mS/cm, less than about 20 mS/cm, less than about 10 mS/cm, less than about 5 mS/cm, less than about 1 mS/cm, less than about 0.5 mS/cm, less than about 0.5 μS/cm, less than about 0.1 μS/cm or less than about 0.05 μS/cm.

In some embodiments, the separating step (ii) and/or separating step (iv) comprises a dialysis step, wherein the sorbent is washed with water and cross-flow filtered through an ultrafiltration membrane and/or nanofiltration membrane to decrease the amount of a soluble impurity in the sorbent. In some embodiments, the separating step (ii) and/or separating step (iv) comprises a dialysis step, wherein the sorbent is washed with water and cross-flow filtered through an ultrafiltration membrane and/or nanofiltration membrane to substantially decrease the amount of a soluble impurity in the sorbent. In some embodiments, the separating step (ii) and separating step (iv) comprise a dialysis step, wherein the sorbent is washed with water and cross-flow filtered through an ultrafiltration membrane and/or nanofiltration membrane to decrease the amount of a soluble impurity in the sorbent. In some embodiments, the separating step (ii) comprises a dialysis step, wherein the lithium loaded sorbent is washed with water and cross-flow filtered through an ultrafiltration membrane and/or nanofiltration membrane to decrease the amount of a soluble impurity in the sorbent. In some embodiments, the separating step (iv) comprises a dialysis step, wherein the regenerated sorbent is washed with water and cross-flow filtered through an ultrafiltration membrane and/or nanofiltration membrane to decrease the amount of a soluble impurity in the sorbent.

In some embodiments, the separating step (ii) and/or separating step (iv) comprises cross-flow filtration using an ultrafiltration membrane and/or a nanofiltration membrane. In some embodiments, the separating step (ii) and/or separating step (iv) comprises inside-out filtration using an ultrafiltration membrane and/or a nanofiltration membrane. In some embodiments, the separating step (ii) and/or separating step (iv) comprises outside-in filtration using an ultrafiltration membrane and/or a nanofiltration membrane. In some embodiments, the separating step (ii) and/or separating step (iv) comprises inside-out cross-flow filtration using an ultrafiltration membrane and/or a nanofiltration membrane. In some embodiments, the separating step (ii) and/or separating step (iv) comprises outside-in cross-flow filtration using an ultrafiltration membrane and/or a nanofiltration membrane.

In some embodiments, the ultrafiltration membrane and/or nanofiltration membrane is a hollow fiber or spiral wound membrane. In some embodiments, the ultrafiltration membrane and/or nanofiltration membrane is part of a crossflow system. In some embodiments, the ultrafiltration membrane and/or nanofiltration membrane is a PES or PVDF hollow fibre membrane. In some embodiments, the nanofiltration membrane is a PVDF outside-in hollow fibre membrane.

In some embodiments, step (ii) and/or step (iv) is performed with a back pressure ranging from about 0 to 3 bar, about 0 to 2 bar, about 0 to 1 bar or about 0.1 to 0.8 bar (e.g., when using a 4 m² membrane). In some embodiments, a back washing process is performed to remove solids built-up on a surface of the ultrafiltration membrane and/or nanofiltration membrane.

In some embodiments, step (ii) and/or step (iv) is performed with a filtration trans-membrane pressure (TMP) ranging from about 0.2 to 3.5 bar with suspended solids varying from 10 wt % to about 60 wt % (for example when using a 4 m² membrane with a rated maximum filtration TMP of about 3 bar).

In some embodiments, step (ii) and/or step (iv) is performed with a filtration differential pressure ranging from about 0.2 to 1.5 bar over each membrane module. In some embodiments, there are multiple membrane modules.

In some embodiments, during step (ii) and/or (iv) a backflush is performed with trans-membrane pressure ranging from 0.2 to 3.5 bar. In some embodiments the backflush solution comprises water. In some embodiments the backflush solution comprises a filtrate produced during step (ii) and/or (iv). In some embodiments the backflush comprises air.

In some embodiments, the ultrafiltration membrane and/or nanofiltration membrane comprises a feed spacer. In some embodiments, the ultrafiltration membrane and/or nanofiltration membrane is a spiral wound membrane and comprises a feed spacer. In some embodiments, the feed spacer is about 0.5 to 2 mm.

In some embodiments, the ultrafiltration membrane and/or nanofiltration membrane comprises several hollow fibers. In some embodiments, the hollow fiber bore size is 0.4 to 1.8 μm.

In some embodiments, step (ii) and/or step (iv) is performed at a temperature ranging from 0 to 100° C., about 0 to 80° C., about 0 to 60° C. or about 0 to 40° C.

In some embodiments, the mixture of the lithium depleted solution and lithium loaded sorbent in step (i) has a concentration of up to about 80 wt % solids or about 60 wt % solids. In some embodiments, the mixture of the lithium depleted solution and lithium loaded sorbent in step (i) has a concentration of about 1 to 55 wt % solids or about 10 to 55 wt % solids. In some embodiments, the mixture of the lithium rich solution and regenerated sorbent in step (iv) has a concentration of up to about 80 wt % solids or about 60 wt % solids. In some embodiments, the lithium rich solution and regenerated sorbent in step (iv) has a concentration of about 1 to 55 wt % solids or about 10 to 55 wt % solids.

In some embodiments, the amount of lithium sorbent contacted with the aqueous solution containing lithium is in excess dose to the amount of lithium in the aqueous solution; preferably the amount of the lithium sorbent is about over 1 to 3 times the dose to the amount of lithium in the aqueous solution.

In some embodiments, the aqueous solution containing lithium is agitated during contacting step (i).

In some embodiments, the lithium sorbent is suspended in the aqueous solution. In some embodiments, the aqueous solution containing lithium is agitated to suspend the sorbent particles during contact with the lithium sorbent. In some embodiments, the aqueous solution containing lithium is stirred vigorously to suspend the sorbent particles when contacted with the lithium sorbent.

In some embodiments, the aqueous solution containing lithium is at a temperature of about 0 to 100° C. when contacted with the lithium sorbent. In some embodiments, the aqueous solution containing lithium is at a temperature of about 0 to less than 100° C. when contacted with the lithium sorbent. In some embodiments, the aqueous solution containing lithium is at a temperature of about 10 to 90° C. when contacted with the lithium sorbent. In some embodiments, the aqueous solution containing lithium is at a temperature of about 20 to 90° C. when contacted with the lithium sorbent. In some embodiments, the aqueous solution containing lithium is at a temperature of about 30 to 90° C. when contacted with the lithium sorbent. In some embodiments, the aqueous solution containing lithium is at a temperature of about 40 to 90° C. when contacted with the lithium sorbent.

In some embodiments, the aqueous solution containing lithium in step (i) is heated.

In some embodiments, the aqueous solution containing lithium in step (i) is not heated.

In some embodiments, the aqueous solution is contacted with the sorbent for about 20 seconds to 12 hours. In some embodiments, the aqueous solution is contacted with the sorbent for about 30 seconds to 12 hours. In some embodiments, the aqueous solution is contacted with the sorbent for about 1 minute to 12 hours. In some embodiments, the aqueous solution is contacted with the sorbent for about 1 minute to 10 hours. In some embodiments, the aqueous solution is contacted with the sorbent for about 1 minute to 8 hours. In some embodiments, the aqueous solution is contacted with the sorbent for about 1 minute to 6 hours. In some embodiments, the aqueous solution is contacted with the sorbent for about 1 minute to 5 hours. In some embodiments, the aqueous solution is contacted with the sorbent for about 1 minute to 4 hours; more preferably the aqueous solution is contacted with the sorbent for about 2 minutes to 4 hours. In some embodiments, the aqueous solution is contacted with the sorbent for about 5 minutes to 3 hours.

In some embodiments, the aqueous solution is contacted with the hydrogen manganese oxide sorbent for about 20 seconds to 12 hours. In some embodiments, the aqueous solution is contacted with the hydrogen manganese oxide sorbent for about 30 seconds to 12 hours. In some embodiments, the aqueous solution is contacted with the hydrogen manganese oxide sorbent for about 1 minute to 12 hours. In some embodiments, the aqueous solution is contacted with the hydrogen manganese oxide sorbent for about 1 minute to 10 hours. In some embodiments, the aqueous solution is contacted with the hydrogen manganese oxide sorbent for about 1 minute to 8 hours. In some embodiments, the aqueous solution is contacted with the hydrogen manganese oxide sorbent for about 1 minute to 6 hours. In some embodiments, the aqueous solution is contacted with the hydrogen manganese oxide sorbent for about 1 minute to 5 hours. In some embodiments, the aqueous solution is contacted with the hydrogen manganese oxide sorbent for about 1 minute to 4 hours. In some embodiments, the aqueous solution is contacted with the hydrogen manganese oxide sorbent for about 2 minutes to 4 hours. In some embodiments, the aqueous solution is contacted with the hydrogen manganese oxide sorbent for about 5 minutes to 3 hours.

In some embodiments, the sorbent is brought into contact with the aqueous solution containing lithium at about 1 to 700 g/L; or, about 1 to 500 g/L; or, about 1 to 200 g/L; or, about 1 to 100 g/L; or, about 1 to 50 g/L.

In some embodiments, the ratio of one or more impurity/Li in the lithium rich solution is decreased relative to an equivalent process in which the lithium depleted solution is provided at a pH above 6. In some embodiments, the ratio of one or more impurity/Li in the lithium rich solution is decreased relative to an equivalent process in which the lithium depleted solution is provided at a pH above 7. In some embodiments, the ratio of one or more impurity/Li in the lithium rich solution is decreased relative to an equivalent process in which the lithium depleted solution is provided at a pH above 8. In some embodiments, the ratio of one or more impurity/Li in the lithium rich solution is decreased relative to an equivalent process in which the lithium depleted solution is provided at a pH above 9. In some embodiments, the ratio of one or more impurity/Li in the lithium rich solution is decreased relative to an equivalent process in which the lithium depleted solution is provided at a pH above 10.

In some embodiments, the ratio of an impurity/Li in the lithium rich solution is less than about 50. In some embodiments, the ratio of an impurity/Li in the lithium rich solution is less than about 20. In some embodiments, the ratio of an impurity/Li in the lithium rich solution is less than about 10. In some embodiments, the ratio of an impurity/Li in the lithium rich solution is less than about 5. In some embodiments, the ratio of an impurity/Li in the lithium rich solution is less than about 5. In some embodiments, the ratio of an impurity/Li in the lithium rich solution is less than about 2. In some embodiments, the ratio of an impurity/Li in the lithium rich solution is less than about 1. In some embodiments, the ratio of an impurity/Li in the lithium rich solution is less than about 0.8. In some embodiments, the ratio of an impurity/Li in the lithium rich solution is less than about 0.5. In some embodiments, the ratio of an impurity/Li in the lithium rich solution is less than about 0.1. In some embodiments, the ratio of an impurity/Li in the lithium rich solution is less than about 0.05. In some embodiments, the ratio of an impurity/Li in the lithium rich solution is less than about 0.01.

In some embodiments, the impurity is a multi-valent ion. In some embodiments, the impurity comprises B, Ba, Ca, Mg, Na, Sr and/or Zn, amongst others.

In some embodiments, the ratio of Ca/Li in the lithium rich solution is decreased relative to a process in which the lithium depleted solution is provided at a pH above 7. In some embodiments, the ratio of Ca/Li in the lithium rich solution is decreased relative to a process in which the lithium depleted solution is provided at a pH above 8. In some embodiments, the ratio of Ca/Li in the lithium rich solution is decreased relative to a process in which the lithium depleted solution is provided at a pH above 9. In some embodiments, the ratio of Ca/Li in the lithium rich solution is decreased relative to a process in which the lithium depleted solution is provided at a pH above 10.

In some embodiments, the ratio of Ca/Li in the lithium rich solution is less than about 50. In some embodiments, the ratio of Ca/Li in the lithium rich solution is less than about 20. In some embodiments, the ratio of Ca/Li in the lithium rich solution is less than about 10. In some embodiments, the ratio of Ca/Li in the lithium rich solution is less than about 5. In some embodiments, the ratio of Ca/Li in the lithium rich solution is less than about 5. In some embodiments, the ratio of Ca/Li in the lithium rich solution is less than about 2. In some embodiments, the ratio of Ca/Li in the lithium rich solution is less than about 1. In some embodiments, the ratio of Ca/Li in the lithium rich solution is less than about 0.5. In some embodiments, the ratio of Ca/Li in the lithium rich solution is less than about 0.01.

In some embodiments, the ratio of Mg/Li in the lithium rich solution is decreased relative to an equivalent process in which the lithium depleted solution is provided at a pH above 7. In some embodiments, the ratio of Mg/Li in the lithium rich solution is decreased relative to an equivalent process in which the lithium depleted solution is provided at a pH above 8. In some embodiments, the ratio of Mg/Li in the lithium rich solution is decreased relative to an equivalent process in which the lithium depleted solution is provided at a pH above 9. In some embodiments, the ratio of Mg/Li in the lithium rich solution is decreased relative to an equivalent process in which the lithium depleted solution is provided at a pH above 10.

In some embodiments, the ratio of Mg/Li in the lithium rich solution is less than about 50. In some embodiments, the ratio of Mg/Li in the lithium rich solution is less than about 20. In some embodiments, the ratio of Mg/Li in the lithium rich solution is less than about 10. In some embodiments, the ratio of Mg/Li in the lithium rich solution is less than about 5. In some embodiments, the ratio of Mg/Li in the lithium rich solution is less than about 5. In some embodiments, the ratio of Mg/Li in the lithium rich solution is less than about 2. In some embodiments, the ratio of Mg/Li in the lithium rich solution is less than about 1. In some embodiments, the ratio of Mg/Li in the lithium rich solution is less than about 0.8. In some embodiments, the ratio of Mg/Li in the lithium rich solution is less than about 0.5. In some embodiments, the ratio of Mg/Li in the lithium rich solution is less than about 0.2. In some embodiments, the ratio of Mg/Li in the lithium rich solution is less than about 0.1. In some embodiments, the ratio of Mg/Li in the lithium rich solution is less than about 0.01.

In some embodiments, the ratio of Na/Li in the lithium rich solution is decreased relative to an equivalent process in which the lithium depleted solution is provided at a pH above 7. In some embodiments, the ratio of Na/Li in the lithium rich solution is decreased relative to an equivalent process in which the lithium depleted solution is provided at a pH above 8. In some embodiments, the ratio of Na/Li in the lithium rich solution is decreased relative to an equivalent process in which the lithium depleted solution is provided at a pH above 9. In some embodiments, the ratio of Na/Li in the lithium rich solution is decreased relative to an equivalent process in which the lithium depleted solution is provided at a pH above 10.

In some embodiments, the ratio of Na/Li in the lithium rich solution is less than about 50. In some embodiments, the ratio of Na/Li in the lithium rich solution is less than about 20. In some embodiments, the ratio of Na/Li in the lithium rich solution is less than about 10. In some embodiments, the ratio of Na/Li in the lithium rich solution is less than about 5. In some embodiments, the ratio of Na/Li in the lithium rich solution is less than about 5. In some embodiments, the ratio of Na/Li in the lithium rich solution is less than about 2.

In some embodiments, the amount of Mn in the lithium rich solution is decreased relative to an equivalent process in which an aqueous solution containing lithium is maintained at an average pH above 7 when the lithium is being absorbed. In some embodiments, the amount of Mn in the lithium rich solution is decreased relative to an equivalent process in which an aqueous solution containing lithium is maintained at an average pH above 8 when the lithium is being absorbed. In some embodiments, the amount of Mn in the lithium rich solution is decreased relative to an equivalent process in which an aqueous solution containing lithium is maintained at an average pH above 9 when the lithium is being absorbed. In some embodiments, the amount of Mn in the lithium rich solution is decreased relative to an equivalent process in which an aqueous solution containing lithium is maintained at an average pH above 10 when the lithium is being absorbed.

In some embodiments, the amount of Mn in the lithium rich solution is decreased relative to an equivalent process in which an aqueous solution containing lithium reaches a maximum pH above 7 when the lithium is being absorbed. In some embodiments, the amount of Mn in the lithium rich solution is decreased relative to an equivalent process in which an aqueous solution containing lithium reaches a maximum pH above 8 when the lithium is being absorbed. In some embodiments, the amount of Mn in the lithium rich solution is decreased relative to an equivalent process in which an aqueous solution containing lithium reaches a maximum pH above 9 when the lithium is being absorbed. In some embodiments, the amount of Mn in the lithium rich solution is decreased relative to an equivalent process in which an aqueous solution containing lithium reaches a maximum pH above 10 when the lithium is being absorbed.

In some embodiments, water is added to the separated lithium loaded sorbent. In some embodiments, the water is added to the separated lithium loaded sorbent to dilute the mixture to about 1 to 1000 g/L, about 200 to 900 g/L, about 400 to 900 g/L, about 600 to 900 g/L or about 700 g/L of the sorbent.

In some embodiments, the treatment in step (iii) comprises contacting the lithium loaded sorbent with an acid to produce a mixture of a lithium rich solution and a regenerated sorbent. In some embodiments, the means for treating the lithium loaded sorbent in (iii) is a source of acid. In some embodiments, the acid in step (iii) or the source of acid is selected from one or more mineral acids and/or organic acids. In some embodiments, the acid in step (iii) or the source of acid is selected from one or more of HCl, H₂SO₄, HBr, HI and phosphoric acid.

In some embodiments, the acid is contacted with the lithium loaded sorbent for about 5 minutes to 3 hours.

In some embodiments, the acid in step (iii) or the source of acid substantially does not dissolve the sorbent.

In some embodiments, the acid in step (iii) or the source of acid is a concentrated or dilute acid.

In some embodiments, the treating step (iii) comprises contacting the lithium loaded sorbent with an oxidizing agent to produce a mixture of a lithium rich solution and a regenerated sorbent. In some embodiments, the means for treating the lithium loaded sorbent in (iii) is an oxidizing agent.

In some embodiments, the process further comprises washing the lithium loaded sorbent; optionally, washing the lithium loaded sorbent with water.

In some embodiments, step (iii) is performed at a temperature of about 0 to 100° C., optionally about 10 to 100° C., about 20 to 100° C., about 30 to 100° C. or about 40 to 100° C. In some embodiments, the regenerated sorbent is reused in step (i) of the process.

In some embodiments, the hydrogen manganese oxide sorbent is produced by leaching the lithium from a lithium manganese oxide with an acid.

In some embodiments, the aqueous solution containing lithium is selected from a geothermal brine, salar brine, formation waters, sea water, concentrates from processing seawater, a waste stream from a lithium processing facility, a waste stream from a battery recycling plants, oil well brines, other ground water.

In some embodiments, the process further comprises milling the lithium sorbent.

In some embodiments, lithium sorbent is milled using a ball mill, a ring mill, a bead mill and/or any other device able to reduce particle size.

In some embodiments, the regenerated sorbent is recycled in the process. In some embodiments, the lithium sorbent shows an initial particle size of 100 μm or less. In some embodiments, the recycled sorbent shows a reduced particle size with the number of cycles performed that is 10 μm or less, 1 μm or less, or 1 to 0.1 μm.

In some embodiments, the lithium sorbent is suspended in the aqueous solution containing lithium.

In some embodiments, one or more of steps (i)-(iv) are performed in a batch process. In some embodiments, all of steps (i)-(iv) are performed in a batch process. In some embodiments, one or more of steps (i)-(iv) are performed in a continuous process. In some embodiments, all of steps (i)-(iv) are performed in a continuous process.

Any of the aforementioned features or embodiments or aspects may be combined with one or more of the other features or embodiments or aspects as described herein.

The term “comprising” as used in this specification and claims means “consisting at least in part of”. When interpreting each statement in this specification and claims that includes the term “comprising”, features other than that or those prefaced by the term may also be present. Related terms such as “comprise” and “comprises” are to be interpreted in the same manner.

It is intended that reference to a range of numbers disclosed herein (for example, 1 to 10) also incorporates reference to all rational numbers within that range (for example, 1, 1.1, 2, 3, 3.9, 4, 5, 6, 6.5, 7, 8, 9 and 10) and also any range of rational numbers within that range (for example, 2 to 8, 1.5 to 5.5 and 3.1 to 4.7) and, therefore, all sub-ranges of all ranges expressly disclosed herein are hereby expressly disclosed. These are only examples of what is specifically intended and all possible combinations of numerical values between the lowest value and the highest value enumerated are to be considered to be expressly stated in this application in a similar manner.

As used herein the term “and/or” means “and” or “or”, or both.

As used herein “(s)” following a noun means the plural and/or singular forms of the noun.

To those skilled in the art to which the invention relates, many changes in construction and widely differing embodiments and applications of the invention will suggest themselves without departing from the scope of the invention as defined in the appended claims. The disclosures and the descriptions herein are purely illustrative and are not intended to be in any sense limiting.

The disclosure consists in the foregoing and also envisages constructions of which the following gives examples only. Features disclosed herein may be combined into new embodiments of compatible components addressing the same or related inventive concepts.

### BRIEF DESCRIPTION OF THE FIGURES

Preferred embodiments of the disclosure will be described by way of example only and with reference to the following drawings.

FIG. 1 shows a graph showing Li in the synthetic brine decreasing with time and the pH of the brine.

FIG. 2 shows a graph showing concentrations of other elements in the brine during the upload process.

FIG. 3 shows a graph showing concentrations of Ca in the brine over time during the upload process and pH.

FIG. 4 shows a graph with lithium concentration versus the upload time in test with an original brine sample.

FIG. 5 shows the concentration of other elements in the original brine sample at different pHs during upload.

FIG. 6 shows a graph with the ratio impurity/Li in LiCl from the upload experiment at pH 5.

FIG. 7 shows a graph with the ratio impurity/Li in LiCl from the upload experiment at pH 6.

FIG. 8 shows a graph with the ratio impurity/Li in LiCl from the upload experiment at pH 7.

FIG. 9 shows a schematic of the membrane trial set up.

FIG. 10 shows a graph of ultrafiltration membrane capability study results showing the feed flow in m³/h versus the sorbent slurry concentration (suspended solids) being filtered.

FIG. 11 shows a graph of ultrafiltration membrane capability study results showing the flux flow in m³/h versus the sorbent slurry concentration (suspended solids) being filtered.

FIG. 12 shows a graph of ultrafiltration membrane capability study results showing the time versus the volume of the sorbent slurry-(suspended solids) being filtered.

FIG. 13 shows a graph of membrane performance during DLE process with a low TDS lithium solution over 200 cycles recycling the same sorbent.

FIG. 14 shows a graph of membrane performance during DLE process with a high TDS lithium solution with a total of 6 cycles recycling the same sorbent.

FIG. 15 shows a graph of backflush frequency for inside-out membranes while processing sorbent-water mixtures.

FIG. 16 shows a graph of backflush frequency for outside-in membranes while processing sorbent-water mixtures.

### DETAILED DESCRIPTION OF THE INVENTION

Described herein is a process for mechanical separation of sorbent particles in the Direct Lithium Extraction Process (DLE). In one aspect, the invention relates to a DLE process and system using an ultrafiltration membrane and/or nanofiltration membrane. This disclosure also relates to process and apparatus that is particularly advantageous for use with a sorbent having an average particle size of less than 100 μm and density of 1.8 to 5.0 g/cm³. In another aspect, the invention relates to a DLE process and system in which the pH is controlled during upload of lithium to a lithium sorbent.

The DLE process generally comprises: (i) contacting an aqueous solution containing lithium with a lithium sorbent to absorb the lithium to produce a mixture of a lithium loaded sorbent and lithium depleted solution, (ii) separating the lithium loaded sorbent and the lithium depleted solution, and (iii) treating the lithium loaded sorbent to produce a mixture of a lithium rich solution and a regenerated sorbent and, optionally (iv) separating the lithium rich solution and the regenerated sorbent.

Step (i) and/or contacting an aqueous solution containing with a sorbent can be referred to as the upload step. The sorbent selectively absorbs lithium into or onto its ion exchange sites and releases hydrogen ions.

The inventors surprisingly have found controlling the pH at the end of step (i), the upload step, is particularly beneficial. As the lithium is absorbed/loaded onto the sorbent, hydrogen ions are released which makes the aqueous solution containing lithium acidic. The inventors have found it is beneficial to provide the lithium depleted solution at a pH of about 3 to 7. It may also be beneficial to maintain the aqueous solution at an average pH of about 3 to 7 when the lithium is being absorbed. The progress of the upload/absorption may be monitored, for example via Inductively Coupled Plasma (ICP), Flame atomic absorption spectroscopy (Flame AA), Ion Chromatography (IC), to determine when the desired absorption/upload is obtained. Preferably the pH of step (i) is maintained at 5 to 7 while the lithium is being absorbed, and/or when the absorption step is stopped, and/or just prior to the next step.

Accordingly, in an aspect, there is described herein a process for extracting lithium from an aqueous solution containing lithium, the process comprising, (i) contacting an aqueous solution containing lithium with a lithium sorbent to produce a lithium loaded sorbent and lithium depleted solution, (ii) separating the lithium loaded sorbent and the lithium depleted solution, (iii) contacting the lithium loaded sorbent with an acid to produce a lithium rich solution and regenerated sorbent, wherein the pH in step (i) is controlled to provide the lithium depleted solution at a pH of about 3 to 7.

In a further or alternative aspect there is described herein a system for extracting lithium from an aqueous solution containing lithium, the system comprising, a container for contacting an aqueous solution containing lithium with a lithium sorbent to absorb the lithium to produce a lithium loaded sorbent and lithium depleted solution, pH control to control the pH of the aqueous solution to provide the lithium depleted solution at a pH of about 3 to 7, a pH monitor to measure the pH of the aqueous solution containing lithium and/or the lithium depleted solution, means to separate the lithium loaded sorbent and the lithium depleted solution, a source of acid to treat the lithium loaded sorbent to produce a lithium rich solution and regenerated sorbent.

The term “container” as used herein refers to a single container or a series of containers. For example, the first container may be a single container selected from an agitated tank, a recirculation tank or other suitable reactor vessel. Alternatively, the first container may be a series of two or more containers selected from an agitated tank, a recirculation tank or other suitable reaction vessel or a combination of any two or more thereof.

A base may be added to maintain the pH while the lithium is being absorbed. Suitable bases include, but are not limited to, NaOH, Ca(OH)₂, CaCO₃, Na₂CO₃, NH₃OH and/or NaHCO₃. The addition of the base if not controlled may cause localized precipitation, it is therefore preferred that the base is added at a rate (i.e. gradually) and/or a dilute base is used such that localized precipitation is reduced when compared to addition of the base in a single load.

Alternatively, the aqueous solution may comprise a natural buffer capacity to maintain the pH while the lithium is being absorbed. For example, the aqueous solution may contain a buffer such as borate or bicarbonate.

Preferably the lithium depleted solution has a pH of about 3.0 to 6.9 once absorption is substantially completed, and/or when the absorption step is stopped, and/or just prior to the next step, or a pH of about 3.0 to 6.0 or a pH of about 3.0 to 5.8, or a pH of about 3.0 to 5.5. Most preferably, the lithium depleted solution has a pH of about 4.0 to 5.5 once absorption is substantially completed as desired and/or absorption step is stopped and/or just prior to the next step. As discussed above, the release of hydrogen ions from the sorbent as the lithium is loaded or absorbed makes the solution acidic in the absence of pH control, however pH adjustment may be used if required. Advantageously, controlling the pH in step (i) to provide the lithium depleted solution at a pH of about 3 to 7, preferably about 3 to 6, more preferably about 4 to 5.5, improves selectivity for the absorption of lithium over other ions and/or reduces precipitation of solids, e.g. salts. Accordingly, the invention provides an optimized DLE process with improved selectivity for lithium.

The inventors have found the combination of the neutral pH followed by the acidic pH may reduce damage to the sorbent (for example the sorbent dissolving in the aqueous solution) and/or reduces contamination of the sorbent and/or reduces carry over of calcium in the aqueous solution containing lithium to the lithium rich solution. Additionally, the inventors discovered that exposing the sorbent to pH above 7, particularly above 9, more particularly above 10, may result in degradation of the sorbent. It is believed that alkaline conditions cause hydroxylation of the sorbent surface. For example, at higher pH (alkaline range) the sorbent's surface can be represented as Mn—OH⁻ and the OH— or H₂O can dissociate readily from Mn3+ due to Jahn-Teller distortion. The effect of these surface reactions results in a sorbent more prone to degradation in the acid elution process. The degradation may be observed by measuring Mn in the eluate that has leached from the sorbent as Mn 2+. The alkaline pH range can also result in more impurity carry over due to the physically attraction of the positively charged ions in the brine onto the negatively charged sorbent's surface (e.g. Mn—OH⁻). On the other hand, at lower pH (acidic range) the surface O atoms bound to Mn can be represented as Mn—OH or Mn—OH₂⁺ due to protonation of the sorbent surface, which is less prone to absorb positively charged impurities. Therefore, the pH control can be used as a tool to reduce impurities on the sorbent's surface while maintaining the lithium exchange reaction.

Although the optimum pH range to increase the lithium extraction rate is in the alkaline pH range, the inventors have discovered that the optimum pH range to maintain lithium extraction and reduce the level of impurities is between pH 4 to 5.5, resulting in a highly selective sorbent to lithium ions.

Accordingly, in some embodiments, the pH of the aqueous solution is maintained at a neutral pH during the upload step and allowed to become more acidic at the end of the upload step. In some embodiments, the aqueous solution is maintained at a pH of about 3 to 7 when the lithium is being absorbed. In some embodiments, the aqueous solution is maintained at an average pH of about 3 to 7 when the lithium is being absorbed. In some embodiments, the aqueous solution is maintained at or below a maximum pH of about 7 when the lithium is being absorbed. In some embodiments, the aqueous solution is maintained below a maximum pH of about 8 when the lithium is being absorbed. In some embodiments, the aqueous solution is maintained below a maximum pH of about 9 when the lithium is being absorbed.

Once the lithium has been absorbed, the lithium loaded sorbent is separated from the lithium depleted solution in step (ii). This can be achieved, e.g., by ultrafiltration or nanofiltration, as the lithium loaded sorbent largely remains a solid. Other means of separating the solid lithium loaded sorbent and the lithium depleted solution will be apparent to a person skilled in the art. When the sorbent is at low concentrations, a pre-concentration filtration method or settling can be used to concentrate the sorbent before it is further concentrated with another method. In some cases, the sorbent can be concentrated to a slurry and eluted as a slurry. Once separated, the lithium depleted solution may be disposed of or, may be further processed or, particularly when the aqueous solution containing lithium came directly or indirectly from a ground water (for example a geothermal water) it can be reinjected into the ground.

Ultrafiltration, nanofiltration or a combination of both may be used to separate the sorbent particles from a fluid (i.e. dewatering) at various stages of the process, e.g., separating the lithium loaded sorbent and the lithium depleted solution in step (ii) and/or separating the lithium rich solution and the regenerated sorbent in step (iv). Advantageously, it has been found that ultrafiltration can be an effective method to separate sorbent particles contacted with a fluid in a slurry form.

Additionally or alternatively, ultrafiltration, nanofiltration or a combination of both may be used for dialysis of the sorbent at various stages of the process, e.g., in step (ii) or step (iv). Dialysis involves washing the sorbent with water, e.g. deionized water, and filtering through an ultrafiltration membrane and/or nanofiltration membrane. The washing step may be carried out by continuously adding water to the mixture comprising the sorbent while filtering the mixture through an ultrafiltration membrane and/or nanofiltration membrane. Advantageously, dialysis may remove one or more soluble impurities, such as an unwanted ion from the sorbent. In some embodiments, dialysis may be used to remove substantially all of one or more impurities. Removal of impurities may be monitored by measuring the conductivity of the filtrate.

Ultrafiltration and/or nanofiltration may be performed by passing a slurry comprising the sorbent, e.g., the mixture comprising the lithium loaded sorbent and the lithium depleted solution through an ultrafiltration membrane and/or nanofiltration membrane. The membrane operation may be optimized by control of variables such as temperature, TMP and the solids concentration. In addition, these variables are dependent on the membrane's specifications. For example, for a 4″×40″ membrane (4 m² membrane), the maximum trans-membrane pressure (TPM) may be 3.5 bar, temperature range may be 0 to 50° C. and a sorbent slurry concentration up to 60 wt %.

The ultrafiltration and/or nanofiltration may be performed with an ultrafiltration membrane and/or nanofiltration membrane, e.g., a tubular, spiral wound or hollowfiber ultrafiltration membrane. Suitable ultrafiltration membrane and/or nanofiltration membrane materials include, but are not limited to, polyethersulfone and polyacrylonitrile and other polymers with a molecular cut-off weight of about 5,000 to 100,000. The ultrafiltration and/or nanofiltration is preferably cross-flow filtration. The ultrafiltration and/or nanofiltration may be performed as inside-out filtration or outside-in filtration. In some embodiments, the ultrafiltration membrane and/or nanofiltration membrane comprises a feed spacer. Advantageously, a feed spacer may allow flow at higher viscosities. In some embodiments, a hollow fiber membrane may utilize an inside-out or outside-in filtration mode. Advantageously, an outside-in membrane may allow for efficient operation at higher solids concentrations.

The control of pH during the upload (e.g. at a pH of about 3 to 7, preferably 3 to 6 or 3 to 5.5, more preferably 4 to 5.5) especially beneficial when the lithium sorbent is a micronized sorbent. Precipitation of solids, particularly at the end of the upload step, is problematic when a micronized sorbent is used because it is difficult to separate the unwanted solids from the sorbent. The unwanted solids can also cause problems during separation of the sorbent with ultrafiltration and/or nanofiltration.

In some embodiments, the regenerated sorbent is recycled in the process. In some embodiments the lithium sorbent shows an initial particle size of 100 μm or less. Typically, the particle size of the lithium sorbent will decrease as the number of cycles performed increases. In some embodiments the recycled manganese sorbent shows a reduced particle size with the number of cycles performed that can be 10 μm or less, 1 μm or less, or 1 to 0.1 μm.

In some embodiments, the mixture comprising the aqueous solution containing lithium and the lithium sorbent is pumped using a pump suitable for high solids slurries, e.g., using a centrifugal pump, positive displacement pump, peristaltic pump, low shear pump, etc.

In some embodiments, one or more of steps (i)-(iv) are performed in a batch process. In some embodiments, steps (i)-(iv) are performed in a batch process. In some embodiments, one or more of steps (i)-(iv) are performed in a continuous process. In some embodiments, steps (i)-(iv) are performed in a continuous process.

In order to recover the lithium from the lithium loaded sorbent, the sorbent is treated under conditions that cause the lithium to be released from the sorbent. For example, the sorbent may be brought into contact with an acid (for example washed or mixed with). This may be referred to as the elution step or unload step. The hydrogen ions exchange for lithium in the porous structure releasing the lithium and regenerating the sorbent. The lithium loaded sorbent may be suspended in water at 1 to 1000 g/L, preferably around 700 g/l. Acid may then be added to the suspended sorbent to release the lithium. HCl is the preferable acid although other acids such as H₂SO₄, HBr, HI and phosphoric acid may be used. The acid may be a recycled stream in the process. Some organic acids may be used although some, such as oxalic acid or citric acid, may dissolve the sorbent so are less preferred. The acid may be added all at once or preferably slowly (e.g. over 20 minutes), the acid may be added in excess or at a 1:1 stoichiometric ratio to the lithium held by the sorbent or until a stable pH around 1-2 is achieved. Alternatively, the lithium loaded sorbent may be treated with an oxidizing agent to release the lithium and regenerate the sorbent.

The lithium rich solution and regenerated sorbent may be separated, e.g., by ultrafiltration or other means. The lithium rich solution may be further processed (as discussed herein). The regenerated sorbent may be reused in the process, i.e. sent back to the upload step (i).

The aqueous solution containing lithium preferably is mixed with the lithium sorbent and agitated. The lithium sorbent is usually a powder; although the sorbent could be in the form of a pellet or bead or present as a filter cake or in a column that the aqueous solution containing lithium passes through. The sorbent and aqueous solution containing lithium are preferably agitated together until the lithium absorbs into the sorbent. This process typically takes 40 minutes although it can take minutes to hours depending on the sorbent particle size, sorbent dose, temperature, pH, etc. The sorbent preferably is added in a slight excess to the amount needed to absorb the lithium e.g. in a brine containing 200 ppm lithium, a sorbent with a capacity of 10 mg/g Li would be added at a rate of approximately >20 g/l to be in excess.

Advantageously, the process of the present invention utilizes ultrafiltration to allow the process to be carried out with a micronized lithium sorbent, e.g, a lithium sorbent comprising particles having a particle size below 100 μm and potentially much smaller such as 0.1 μm. The micronized lithium sorbent may be added to the process or formed during the process, i.e., by reduction of the particle size of the lithium sorbent. The micronized lithium sorbent may have an average particle size of less than about 100 μm. In some embodiments, the micronized lithium sorbent has a particle size distribution ranging from about 100 to 0.01 μm. Advantageously, ultrafiltration may separate sorbent particles with a wide particle size distribution that lies below 100 μm. For example, ultrafiltration may be used to separate micronized lithium sorbent particles having a particle size distribution of about 100 to 0.1 μm, e.g. about 10 to 0.1 μm.

It has been found that the hotter the brine/aqueous solution containing lithium and the faster the brine and sorbent are mixed the faster the upload process. The rate of stirring will depend on the size of the container. However, in general agitation, in particular relatively high agitation, has been found to be beneficial to the upload/absorbance rate. The temperature of the brine/aqueous solution containing lithium appears to have an effect on the load capacity of the sorbent. Generally, the warmer the brine/aqueous solution containing lithium the higher the capacity. The aqueous solution containing lithium may be at a temperature of about 10 to less than 100° C. (for example 100° C.) when contacted with the lithium sorbent. However, preferably the aqueous solution containing lithium is at a temperature of about 30 to 100° C. when contacted with the lithium sorbent.

Lithium sorbents are described, for example in Johnson Matthey Technol. Rev., 2018, 62, (2), 161-176 “Lithium Recovery from Aqueous Resources and Batteries: A Brief Review”. The lithium sorbent may be a metal oxide-based ion exchange sorbent. For example, suitable metal oxide-based ion exchange sorbents may include a hydrogen manganese oxide sorbent, a hydrogen titanium oxide sorbent, a hydrogen manganese phosphate, a hydrogen iron phosphate, a hydrogen aluminium oxide and/or a hydrogen copper oxide. Conventional sorbents capable of absorbing lithium known in the art may be useful in the invention, e.g., LiTiO₂, Li₂TiO₃, LiaTiO₂, Li₄TiO₄, Li₂Ti₁₀O₂₄, LiMn₂O₄, Li_{1.67}Mn_{1.67}O₄, Li_{1.33}Mn_{1.67}O₄, Li_{X.2}Al(OH)₃, LiAlO₂, LiMnPO₄, LiFePO₄ and/or LiCuO₂. Such sorbent precursors may be activated, if required, to form the lithium sorbent, e.g. by treatment with an acid to exchange the lithium for hydrogen. The lithium sorbent is preferably a hydrogen manganese oxide sorbent or a hydrogen titanium oxide sorbent, preferably a hydrogen manganese oxide sorbent. The sorbent is preferably selected from lambda-phase manganese sorbents (λ-MnO₂) also known as lithium manganese oxide (LMO) sorbents.

For example, a hydrogen manganese oxide sorbent is made by heating (for example in a furnace) solid manganese oxide with a lithium source (for example a lithium salt) to provide a lithium manganese oxide. The lithium manganese oxide is then treated with an acid to exchange the lithium for hydrogen to give a hydrogen manganese oxide sorbent.

The amount of sorbent used in step (i) is preferably in excess dose to the amount of lithium in the aqueous solution. For example, the sorbent dose may be based on a 10 mg/g capacity (mg of lithium/grams of sorbent). Preferably the sorbent in step (i) is in about greater than 1 to 3 times the dose to the amount of lithium in the in the aqueous solution.

As an example of the sorbent being added in a slight excess to the amount needed to absorb the lithium, for an aqueous solution containing 200 ppm lithium, a sorbent with a capacity of 10 mg/g Li may be added at a rate >20 g/l to be in excess. Advantageously, addition of excess sorbent may decrease the process time.

The aqueous solution containing lithium may be obtained from a range of sources, for example, geothermal brine, salar brine, sea water, concentrates from processing seawater, a waste stream from a lithium processing facility, a waste stream from a battery recycling plant, oil well brines, produced water, fracking water, pre-treated brine and other ground water. For example, geothermal brine may be used which has been processed by a silica extraction plant to remove or reduce silica content. Some sources may be naturally warm (for example 40° C.) without the need to heat the aqueous solution containing lithium, for example a geothermal source. Some sources will be cold brines that do not require heating.

The aqueous solution containing lithium will generally comprise other minerals, ions and compounds which are preferably separated or reduced from the aqueous solution containing lithium by the process and/or system. For example, common contaminants are silica, sodium, strontium, potassium, magnesium, manganese, boron, barium, zinc, iron and/or calcium.

Various embodiments are described with reference to the Figures. Throughout the Figures and specification, the same reference numerals may be used to designate the same or similar components, and redundant descriptions thereof may be omitted.

The following non-limiting examples are provided to illustrate the present invention and in no way limit the scope thereof.

### EXAMPLES

### Example 1: Extraction of Lithium from a Synthetic Aqueous Solution

### 1.1 Synthetic Brine Preparation (Aqueous Solution Containing Lithium)

A synthetic brine (aqueous solution containing lithium) was prepared by dissolving NaCl, BaCl₂, NaHCO₃, BOH₃, CaCl₂SrCl₂, LiOH·H₂O, KCl, ZnCl₂ and CsCl in tap water (which contained Mg and As). MnCO₃ was added to HBr and added to the solution. Finally, HCl was added to adjust the pH of the solution to 7.8. A sample of the synthetic brine was filtered at 0.45 μm and analysed by inductively coupled plasma-optical emission spectroscopy (ICP-OES).

The composition of the synthetic brine is given in Table 1.

TABLE 1
The synthetic brine composition.

| Elements | Synthetic |
|---|---|
| (ppm) | Brine Analysis |
| A1 | 0.42 |
| As | 0.02 |
| B | 67.96 |
| Ba | 2.09 |
| Br | NA* |
| Ca | 1606.26 |
| Cd | 0 |
| Cl | NA* |
| Co | 0.01 |
| Cr | ND |
| Cs | NA* |
| Cu | 0.04 |
| Fe | ND |
| K | 443.51 |
| Li | 239.46 |
| Mg | 9.97 |
| Mn | 1.53 |
| Mo | ND |
| Na | 5518.78 |
| Ni | 0.01 |
| Pb | 0 |
| Rb | NA |
| S | NA |
| Si | 56.85 |
| Sr | 31.59 |
| W | NA |
| Zn | 0.31 |

In Table 1, NA = not available, ND = Not Detected.
Note
* = added but unmeasured.

### 1.1 Lithium Upload Lab Scale Test

To the synthetic brine (aqueous solution containing lithium), the equivalent of 36 g/l of lambda phase manganese dioxide sorbent was added. The brine and sorbent were agitated for 3 hours at 40° C. The synthetic brine and sorbent were separated using a 0.45-micron filter.

Samples were taken during the upload process and were analysed by ICP-OES. A 3 wt % sodium hydroxide solution was added dropwise to control the pH between 3 and 8.58.

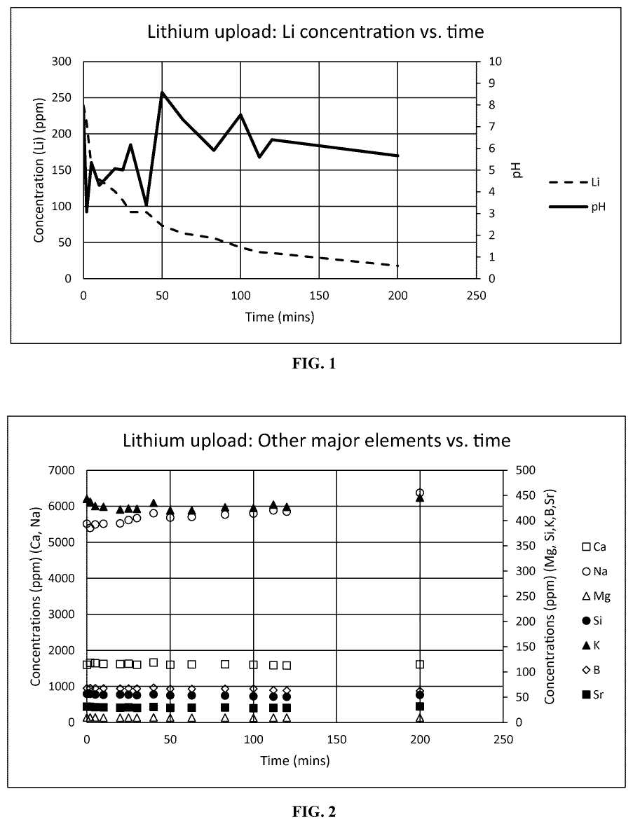

The addition of the sorbent to the synthetic brine turned the fluid black so little was observable. However, the ICP-OES results showed the sorbent was absorbing lithium over the 3 hour period, see FIG. 1. The lithium concentration in the solution was reduced from 239 to 17.8 ppm, representing 93% recovery. The lithium concentration could have been reduced more by adding more sorbent or leaving the solution for longer.

Sodium hydroxide was added regularly to increase the pH as the sorbent released hydrogen lowering the pH and preventing lithium uptake, see FIG. 1.

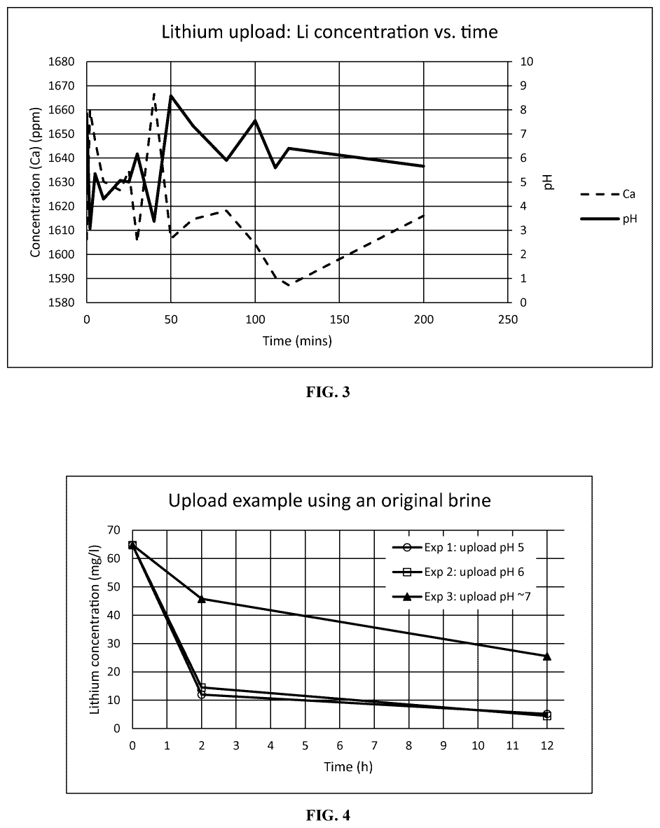

The concentrations of other elements in the synthetic brine were monitored during the upload process, see FIG. 2. The absorption of some non-target elements such as Mn, Ba and Zn was observed, though these were very low in concentration in the brine. On the other hand, the concentrations of the major elements such as Ca, Mg Na, B, K, Sr and Si were extremely stable over the 3-hour upload process. Mg, Ca, Na, B and K are the elements most battery-grade lithium carbonate producers list on their technical datasheets, so are important contaminants to control.

### 1.2 Lithium Elution

The lithium loaded sorbent was placed in 600 ml deionized (DI) water and unloaded (eluted) by the addition of 36 wt % hydrochloric acid to a pH of 1.5 over 30 minutes. Once the unloading was complete, the unloaded (regenerated) sorbent was separated by filtration and washed. This sorbent was then be ready for another upload cycle. The filtrate (eluate/lithium rich liquor) was analysed by ICP-OES.

As can be seen in Table 2, the eluate was rich in lithium and relatively free of impurities. The major carry-over element was Ca, likely as a hydroxide that would have been filtered out along with the sorbent. Other 2+ ions, such as Ba and Sr may have also been carried over as co-precipitates in the calcium hydroxide matrix. Had the pH of the brine near the end of the upload process not been acidic, the Ca carryover would have been much greater.

TABLE 2
ICP-OES analysis of lithium-rich eluate.

| Elements (ppm) | Lithium Rich Eluate |
|---|---|
| A1 | 1.12 |
| As | ND |
| B | ND |
| Ba | 6.29 |
| Ca | 57.62 |
| Cd | 0 |
| Co | 0.02 |
| Cr | 0 |
| Cu | 0.03 |
| Fe | 0.03 |
| K | 6.61 |
| Li | 846.55 |
| Mg | 0.56 |
| Mn | 6.59 |
| Mo | 0.01 |
| Na | ND |
| Ni | 0.02 |
| Pb | 0.02 |
| Si | 5.25 |
| Sr | 4.14 |
| Zn | 0.49 |

The lithium-rich concentrate was then treated with a source of carbonate to separate impurities and also to produce lithium carbonate (Li₂CO₃).

### Example 2: pH VS Sorbent Capacity and Selectivity

Hydrogen manganese oxide sorbent was contacted with a synthetic brine containing 30 ppm Li, Ca 16 ppm, Mg 6 ppm and Sr 1 ppm. The hydrogen manganese oxide was agitated with the brine at 3 g/l. The pH was corrected by the addition of 3% NaOH. The final pH of the upload was controlled ending at 3 to 11. At the end of the upload process, the lithium manganese oxide was filtered out, washed and contacted with a dilute HCl solution to release the lithium. The composition of the resulting eluate was analysed by ICP-OES.

Table 3 shows the amount of Ca, Mg, Sr and Zn in the lithium rich eluate increases as the pH during the upload increases. It is also observed that the lithium in the regeneration solution increases with pH, this is because the upload capacity increases. Furthermore, as the pH increases above 10, Mn in the eluate increases. This is due to the hydroxylation of the Mn due in alkaline conditions.

TABLE 4
ICP-OES analysis of the eluate vs pH of upload.

| | Li | Mn | Al | Ca | Mg | Sr | Zn |
|---|---|---|---|---|---|---|---|
| pH | (ppm) | (ppm | (ppm | (ppm) | (ppm) | (ppm) | (ppm) |
| 3 | 10.85 | 1.09 | 0.12 | 5.12 | 1.23 | 0.01 | 0.6 |
| 4 | 18.97 | 0.76 | 0.05 | 4.82 | 0.97 | 0.01 | 0.11 |
| 5 | 37.99 | 1.24 | 0.08 | 6.84 | 1.12 | 0.03 | 0.13 |
| 7 | 54.02 | 1.82 | 0.1 | 12.3 | 1.77 | 0.08 | 0.16 |
| 8 | 57.94 | 2.03 | 0.57 | 18.46 | 2.87 | 0.16 | 0.19 |
| 9 | 39.49 | 1.66 | 0.09 | 13.53 | 2.1 | 0.09 | 0.13 |
| 10 | 52.46 | 5.03 | 0.18 | 18.37 | 4.07 | 0.14 | 0.15 |
| 11 | 56.77 | 15.82 | 0.11 | 22.22 | 7.53 | 0.16 | 0.19 |

FIG. 3 shows the Li/Ca ratio in elution step (LiCl) from experiments using a synthetic brine comparing uploads performed with different end pHs. An increase in Li/Ca ratio with the increase on the end pH in upload was observed. For example, upload experiment with end pH=5 resulted in lower Ca carry over when compared to upload experiment with end pH=8. The linear correlation of the Li/Ca ratio is R²=0.89 which indicates a linear correlation of the end pH in upload with Li/Ca ratio in elution.

### Example 3: Extraction of Lithium from an Original Brine

### 3.1 Lithium Upload Test Using an Original Brine as Example

To an original oilfield brine (aqueous solution containing lithium), the equivalent of 6 g/l of lambda phase manganese dioxide sorbent (lithium sorbent) was added. The composition of the oilfield brine is shown in Table 5. The brine and sorbent were agitated up to 12 hours at ambient temperature to investigate the equilibrium reaction. The oilfield brine and sorbent were separated using a 0.45-micron filter.

Samples were taken during the upload process and analysed by ICP-OES. A 10 wt % sodium carbonate solution (Na₂CO₃) was added dropwise to control the pH during upload. Three experiments were carried out with the pH in upload controlled at experiment 1: pH 5, experiment 2: pH 6, and experiment 3: pH 7.

The ICP-OES results showed the sorbent was absorbing lithium over the 12 hour period, see FIG. 4. The lithium concentration in the solution was reduced from 65 to 5.2, 4.5 and 25.6 mg/l (ppm) for experiments 1, 2 and 3, respectively.

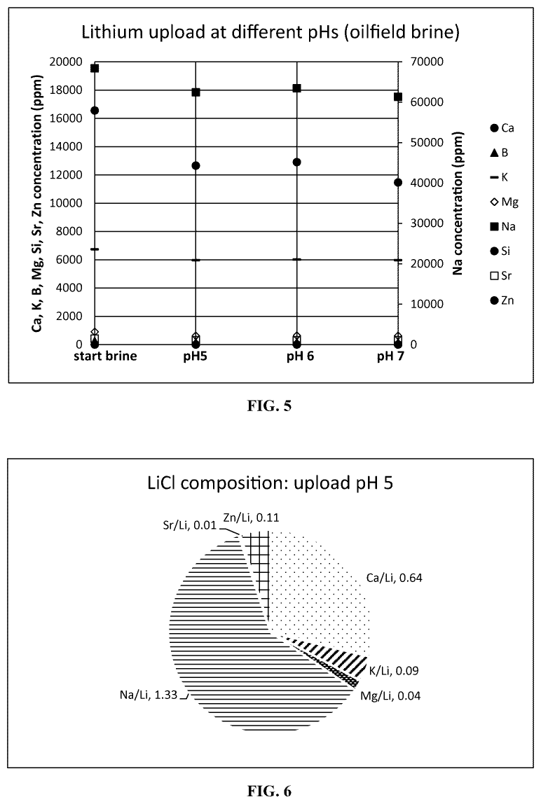

The concentrations of other elements in the original oilfield brine were monitored during the upload process, see FIG. 5. The absorption of some non-target elements such as Mn, Si and Zn was observed for all the experiments, though these were very low in concentration in the brine. The concentrations of other major elements such as Mg, Na, Ca, B, K and Sr were also observed to decrease during upload in all three experiments. However, Ca uptake was more significant for experiment 3, performed at pH 7. In this experiment an excess of 10% Na₂CO₃ was added as pH control and therefore the concentration of the ions was lower when compared to experiments 1 and 2. Another observation was the change in the sorbent slurry color from black to grey during upload with the addition of pH control, this was only observed for experiment 3, which was due to the precipitation of other salts in solution. Mg, Ca, Na, B and K are the elements most battery-grade lithium carbonate producers list on their technical datasheets, so are important contaminants to control. Therefore, the pH control is very important to minimize impurity carry over in upload that can negatively affect the product lithium salt grade.

TABLE 5
The original brine composition.

| Elements | Oilfield |
|---|---|
| (ppm) | Brine Analysis |
| B | 262 |
| Ca | 16554 |
| Fe | 1 |
| K | 6743 |
| Li | 65 |
| Mg | 910 |
| Mn | 18 |
| Na | 68416 |
| Si | 5 |
| Sr | 1479 |
| Zn | 11 |

### 3.2 Lithium Elution

The lithium loaded sorbents from experiments 1, 2 and 3 were each placed in 100 ml DI water in a beaker, and unloaded (eluted) by the addition of 36 wt % hydrochloric acid to a pH of 1.5 over 30 minutes. Once the unloading was complete, the unloaded (regenerated) sorbent was separated by filtration and washed. This sorbent was then ready for another cycle. The filtrate (eluate/lithium rich liquor) was analysed by ICP-OES.

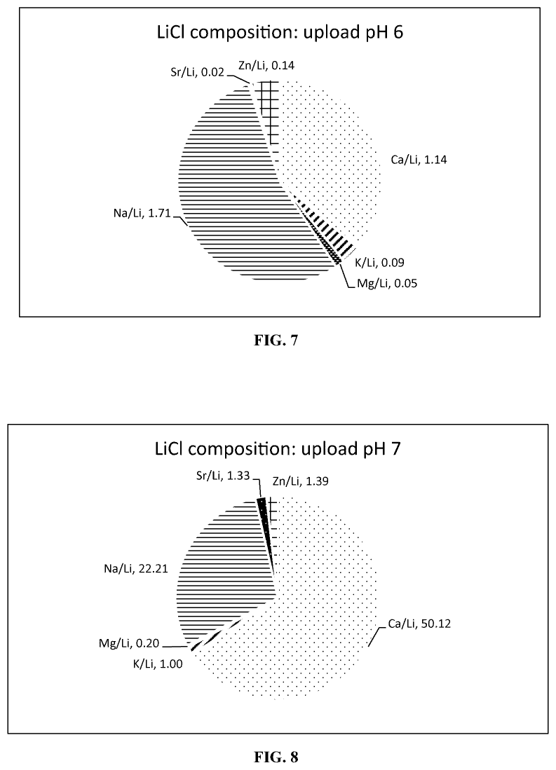

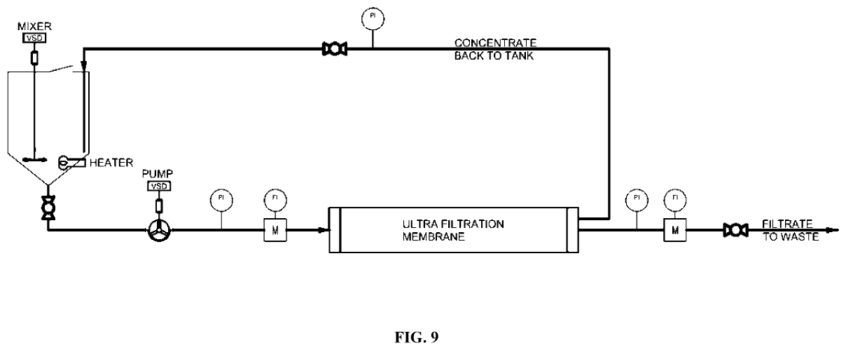

As can be seen in Table 6, the eluate in experiment 1 (upload at pH 5), was rich in lithium and relatively free of impurities. The major carry-over element was Ca, likely as a hydroxide that would have been filtered out along with the sorbent. However, experiment 3 carried out with pH 7 in upload showed much higher Ca carry over, as evidenced by the LiCl composition as compared to the experiments 1 and 2. Other 2+ ions may have also been carried over as co-precipitates in the calcium hydroxide matrix. FIGS. 6, 7 and 8 show the LiCl composition with the percentage mass ratio of impurity/lithium for each of the three experiments performed. It was observed that Na and Ca are the main impurities in the LiCl samples and that the pH=5 in upload can significantly reduce the level of contaminants. Additionally, as shown in FIGS. 6, 7, 8 and Table 6, the total amount of contaminants is reduced at lower pH.

TABLE 6
ICP-OES analysis of lithium-rich eluate.

| Elements | LiCl exp | LiCl exp | LiCl exp |
|---|---|---|---|
| (ppm) | 1 (pH 5) | 2 (pH 6) | 3 (pH 7) |
| B | 0.79 | 1.14 | 6.09 |
| Ca | 70.44 | 113.51 | 4197.07 |
| Fe | 0.18 | 0.27 | 0.79 |
| K | 9.82 | 9.37 | 83.81 |
| Li | 110.57 | 99.32 | 83.74 |
| Mg | 4.09 | 4.72 | 16.99 |
| Mn | 72.66 | 52.85 | 70.54 |
| Na | 147.42 | 169.94 | 1859.96 |
| Si | 12.85 | 12.65 | 10.23 |
| Sr | 0.7 | 1.55 | 111.59 |
| Zn | 11.68 | 14.12 | 116.56 |

### Example 4: Membrane Capability Study with Increasing Sorbent Slurry Concentration

A capability study was carried out to investigate the effect of the sorbent slurry concentration on the ultrafiltration membrane's performance. The solution being filtered was lithium manganese oxide sorbent suspended in water to make up a sorbent slurry. The sorbent's density (g/cm³) was in the range of 1.8-5.0. The sorbent slurry was kept under constant agitation in a tank during the trials. A centrifugal pump was used to circulate the sorbent slurry from the tank into the membrane in a circuit. The filtrate was disposed of while the sorbent slurry was concentrated into the tank until the concentration of the suspended solids was about 55 wt %. FIG. 9 is a schematic of the trial set up with a feed tank, pump, ultrafiltration membrane, pressure valves, concentrate and filtrate lines.

In principle, the ultrafiltration membrane works in a cross-flow filtration where the fluid to be filtered is pumped in parallel to the filter's surface and the filtrate is removed perpendicularly to the flow direction. During the concentration of the sorbent slurry, permeate/filtrate is removed so that the volume in the feed tank decreases and the concentration of the retained sorbent slurry increases. However, the solids can only be concentrated to the extent that the suspension or slurry is still pumpable. In this trial, the sorbent slurry was tested with increasing solids concentration to investigate the limits of the membrane operations.

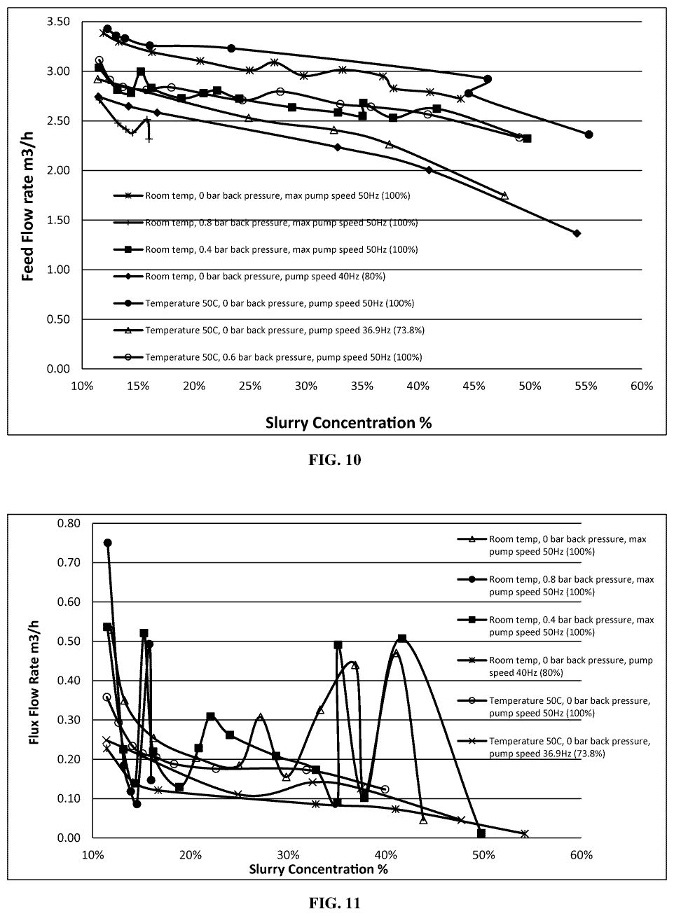

Shown in FIGS. 10 to 12 is the effect of increasing sorbent slurry concentration on the membrane performance. The flux across the membrane is shown in cubic meters of filtrate per hour. Similarly, the concentrate flux is shown in cubic meters per hour. The pump pressure and the membrane's back pressure are shown in bar units. The membrane used in this trial was a 4 m² size ultrafiltration membrane with an outside-in cross flow type.

The membrane operation parameters have been optimized to increase the mass-transport rate during the trials. For example, variables such as temperature, pump speed, membrane back pressure, and cross flow type, have been tested for the different sorbent slurry concentrations (10 to about 55% solids).

FIG. 10 is a summary of the average feed flow versus the sorbent slurry concentration from 10 to 55 wt % solids. The shear forces formed at the membrane's filter surface was controlled by adjusting the pump speed, which controls the volume of the flow that can minimize solids build up (surface layer) out of the solid particles to be separated on the membrane. However, filtration resistance was observed, resulting in pressure loss across the membrane with the increase in solids wt %, as expected. Alternatively, the membrane's back pressure was adjusted using the pressure control valve, which has shown improved flux flow depending on the trial conditions. The sorbent slurry temperature at 50° C. showed slightly improved flux flow as compared to the ambient temperature trials.

The optimum feed flow conditions were observed with full pump speed (100%), temperature of 50° C. and no back pressure during the sorbent slurry concentration. The combination of these operational parameters resulted in a feed flow average of 3.43 m³/h for 10% solids and 2.36 m³/h for the maximum solids concentration tested (about 55 wt % solids), which was still pumpable. In addition to the variables tested and shown in FIG. 10, the feed flow was readily recovered during the trial by applying a back wash process to displace the solids build up on the membrane's surface. This procedure was repeated multiple times for all the trials with the sorbent slurry >30 wt % solids as an alternative to recover the flux flow. In some trials, for example the trial with the back pressure set at 0.8 bar, the flux flow failed to recover using the pulsing operational strategy and the sorbent slurry was concentrated only to a maximum of 16 wt % solids.

The filtrate flow versus the sorbent slurry concentration data is shown in FIG. 11. The filtrate flow is directly affected by the membrane's back pressure and the trials with no back pressure showed more stable filtrate flow with the increasing solids concentration. The membrane's performance was recovered during the trial by applying a back wash process. This procedure minimized the effect of the surface layer build up with the increasing sorbent slurry concentration. Pump operation at low speed (70-80%) showed very low filtrate flow when compared to the full speed trials (100%). However, the filtrate flow was more stable with the low pump speed. This is an example of how the cross flow velocity helps control the filtration boundary layer.

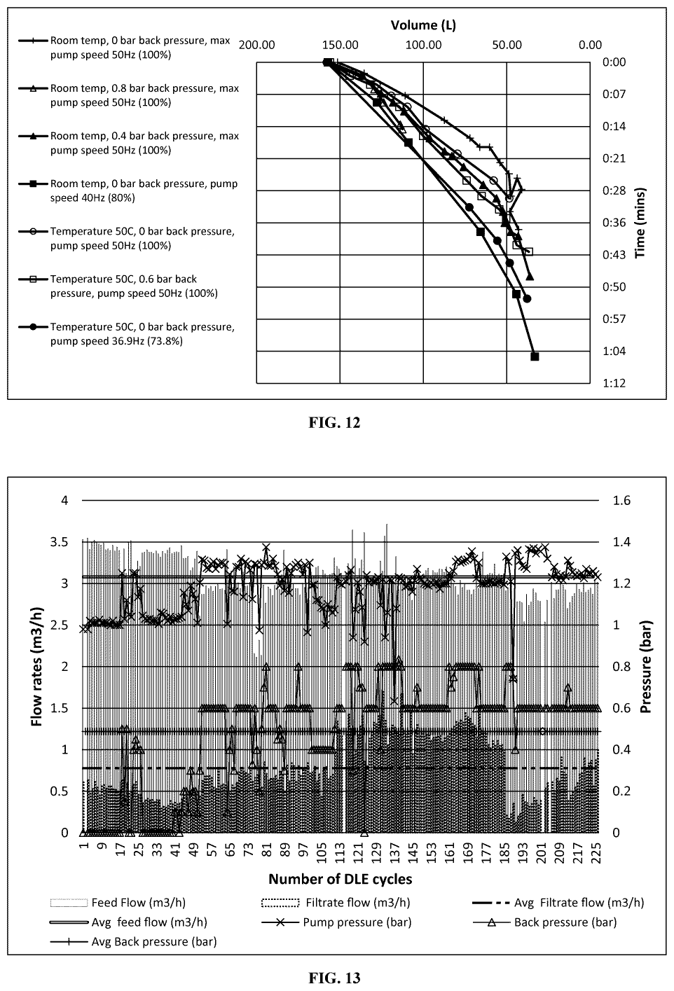

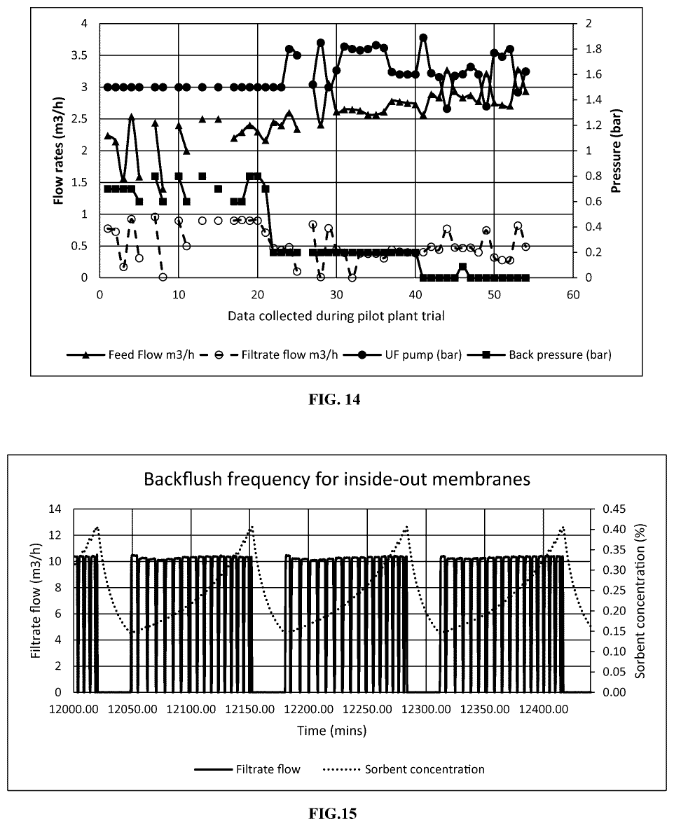

A summary of the time to filter the sorbent slurry with increasing solids concentration from about 10 to 55 wt % is shown in FIG. 12. The optimum conditions were observed with the full pump speed and no back pressure on the membrane. The temperature did not show significant effect on filtration time, for the tests at room temperature and at 50° C.

### Example 5: Membrane Performance was Trialed Recycling the Same Sorbent Over 200 Cycles Using a Lithium Solution with a Total Dissolved Solids (TDS) of 2,500 mg/l

The trial was performed as per FIG. 9 in Example 4. The sorbent was suspended in the lithium solution with a total dissolved solids (TDS) of 2,500 mg/l and kept under constant agitation as part of the lithium upload step. The sorbent slurry concentration was 5 wt % and the trials were performed at ambient temperature. A centrifugal pump was used to circulate the sorbent particles in the ultrafiltration membrane to concentrate the solids. The lithium depleted solution was disposed of at the end of the upload step. The same process was performed during lithium elution with acid, where the lithium loaded sorbent was agitated in the tank with the acidic solution and then circulated in the ultrafiltration membrane to separate the sorbent and the lithium rich solution. The lithium sorbent was then recycled to the front end of the process for another DLE cycle.

The DLE process was carried out for over 200 cycles recycling the same sorbent to evaluate the membrane performance. The sorbent's particle size was analyzed before and after the 200 DLE cycles to investigate the effect of the DLE recycling on its particle size.

The process of recycling the sorbent involves the solid/liquid separation in multiple steps during the DLE process. The ultrafiltration membrane is used to separate the mixture in the DLE process and also to recycle the sorbent for re-use after every DLE cycle completed.

Shown in FIG. 13 is the membrane performance with over 200 DLE cycles completed. The flow rate, the filtrate rate, the pump pressure and membrane back pressure were monitored during the trial. The membrane flux rates were overall very stable during the trials as can be seen in FIG. 13. The average feed flow was 3.08 m³/h and the average filtrate flow was 0.8 m³/h. The centrifugal pump operated at 1.2 bar pressure on average at full speed. The sorbent was recycled over 200 times with no major changes in the membrane performance and its operation.

A decrease in the sorbent particle size can be a result of mechanical grinding the particles during agitation in the tank to keep the particles suspended and in the centrifugal pump, used to circulate the particles through the ultrafiltration membrane. Interestingly, the decrease in sorbent particle size did not negatively affect the DLE process and the membrane performance was stable over the 200 cycles trial of re-using the same sorbent.

This example demonstrates the use of UF membrane to separate manganese oxide sorbent with particle size with a Dv (50) of 10 to 1 μm. The membrane performed well as a solid/liquid separation media for micronized lithium sorbent with a particle distribution varying from 100 to 0.1 microns. The membrane has even been shown to reject 0.01 μm particles, making it ideal for rejecting fine particles from sorbent break down from micronized sorbent as well as other forms (i.e., beads, pellets, etc.) that are susceptible to mechanical degradation with the formation of fine particles that are difficult to filter using common filtration methods.

### Example 6: Membrane Performance in DLE Process Recycling the Same Sorbent for 6 Cycles with a Lithium Solution with a Total Dissolved Solids (TDS) of about 200,000 mg/l

The trial was performed as per FIG. 9 in Example 4. The sorbent was suspended in the lithium solution with a TDS of 200,000 mg/l and kept under constant agitation as part of the lithium upload step. The sorbent slurry concentration was about 10 wt % and the trials were performed at ambient temperature. A centrifugal pump was used to circulate the sorbent particles in the ultrafiltration membrane to concentrate the solids. The lithium depleted solution was disposed of at the end of the upload step. The same process was performed during lithium elution with acid, where the lithium loaded sorbent was agitated in the tank with the acidic solution and then circulated in the ultrafiltration membrane to separate the sorbent and the lithium rich solution. The lithium sorbent was then recycled to the front end of the process for another DLE cycle. A total of 6 cycles were performed in this trial due to the lithium solution availability.

The membrane fluxes were 2.56 and 0.53 on average for the feed and filtrate flow respectively. The pump pressure operated with an average of 1.6 bar. The membrane back pressure became more stable after the DLE cycle 2 with a minor change made to its operation that significantly improved the overall filtration process. This example shows that the ultrafiltration membrane performed well even with lithium solution with high TDS of 200,000 mg/l and at 10 wt % solids concentration.

### Example 7: Membrane Performance and the Conductivity of the Filtrate in the Dialysis Process

The conductivity of the filtrate was also monitored during the trials. Shown in Tables 7 and 8 are the membrane performance with the conductivity during dewatering and dialysis in the DLE process as examples.

The membrane performance was stable during the dewatering process, as can be seen in Table 7. The conductivity of the lithium solution is shown with increasing solids wt % with the filtrate being the lithium depleted solution and the concentrate the lithium loaded sorbent. The dewatering process is an important step in the DLE process to effectively separate the lithium depleted solution. In this example, the suspended solids were concentrated from about 7 to 36 w % using an ultrafiltration membrane.

A summary of the dialysis process is shown in Table 8, where demineralized water is used to dilute and displace the lithium depleted solution entrained in the sorbent particles. The results in Table 8 shows that the ultrafiltration membrane is an effective and fast method to dialyze the sorbent slurry with the filtrate conductivity dropping from 209 mS/cm on average down to 0.46 mS/cm in 23 minutes. For reference, demineralized water has a conductivity of about 0.05 μS/cm.

TABLE 7
Membrane performance in the DLE dewatering process
showing the conductivity of the filtrate.

| | | Suspended | | Pump | Feed | Filtrate | UF back |
|---|---|---|---|---|---|---|---|
| Time | Volume | solids | Conductivity | pressure | Flow | flow | pressure |
| (min) | (L) | (wt %) | (mS/cm) | (bar) | (m3/h) | (m3/h) | (bar) |
| 0:00 | 150.00 | 7 | 209.8 | 1.37 | 2.918 | 0.689 | 0.6 |
| 0:04 | 105.20 | 11 | 209.1 | 1.24 | 3.092 | 1.043 | 0.6 |
| 0:10 | 52.10 | 21 | 208.8 | 1.21 | 3.076 | 1.006 | 0.6 |
| 0:14 | 30.87 | 36 | 208.6 | 1.20 | 3.026 | 0.897 | 0.6 |

TABLE 8
Membrane performance in the DLE dialysis process
showing the conductivity of the filtrate.

| | | Suspended | | Pump | Feed | Filtrate | UF back |
|---|---|---|---|---|---|---|---|
| Time | Volume | solids | Conductivity | pressure | Flow | flow | pressure |
| (min) | (L) | (wt %) | (mS/cm) | (bar) | (m3/h) | (m3/h) | (bar) |
| 0:00 | 35.11 | 32 | 40.1 | 1.15 | 2.999 | 0.920 | 0.6 |
| 0:05 | 30.87 | 36 | 10.47 | 1.13 | 2.978 | 0.852 | 0.6 |
| 0:23 | 32.99 | 34 | 0.46 | 1.14 | 2.933 | 0.784 | 0.6 |

### Example 8: Separation of Sorbent from an Aqueous System

An aqueous system containing sorbent was processed with two types of hollow fiber membranes, within a standard filtration operating system. The membrane types used were an outside-in hollow fiber membrane and an inside-out hollow fiber membrane. These two membranes were tested side by side to determine technology suitability and required backflush frequency. Backflush frequency helps inform water usage required and system capacity required to ensure continuous running of the system, as backflush frequency decreases so does water usage and system capacity requirements.

Within this system one tank held a sorbent/water mix and fed the sorbent/water mix through a hollow fiber membrane by use of a centrifugal pump, while monitoring pre and post membrane pressure, filtrate pressure, feed flow and filtrate flow. The system also contained a secondary centrifugal pump attached to the filtrate holding tank, able to pump filtrate back to the feed holding tank or to utilize filtrate to backflush the hollow fiber membrane. Filtrate flow was controlled via feed pump speed to meet a desired filtrate flow rate and backflushes were triggered on reaching a TMP (trans-membrane pressure) threshold.

The filtrate flow rate for each membrane was determined based on the specified maximum filtrate flow rate for each membrane, this was 5.5 m³/h for the outside in membrane (110 LMH) and 9 m³/h for the inside-out membrane (160 LMH). Backflushes were set to trigger at 0.5 bar TMP.

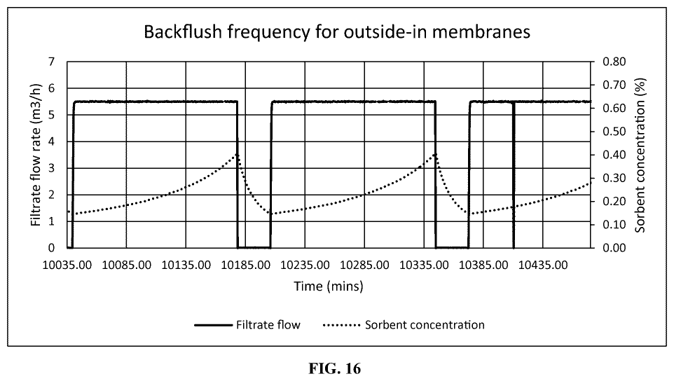

FIG. 15 shows the backflush frequency required by the inside-out hollow fiber membrane and FIG. 16 shows the required backflush frequency by the outside-in hollow fiber membrane. These figures show the reduced backflush frequency required by the outside-in hollow fiber membrane, with backflushes being required on average every 11 minutes by the inside-out membrane and every 300 minutes by the outside-in membrane.

Where, in the foregoing description reference has been made to integers or components having known equivalents thereof, those integers are herein incorporated as if individually set forth.

Although the present disclosure has been described in terms of certain embodiments, other embodiments apparent to those of ordinary skill in the art also are within the scope of this disclosure. Thus, various changes and modifications may be made without departing from the spirit and scope of the disclosure. For instance, various components may be repositioned as desired. Moreover, not all of the features, aspects and advantages are necessarily required to practice the present disclosure. Accordingly, the scope of the present disclosure is intended to be defined only by the claims that follow.

The following numbered paragraphs define particular aspects of the present invention:
1. A process for extracting lithium from an aqueous solution containing lithium, the process comprising:
   (i) contacting an aqueous solution containing lithium with a lithium sorbent to absorb the lithium to produce a mixture of a lithium loaded sorbent and lithium depleted solution,
   (ii) separating the lithium loaded sorbent and the lithium depleted solution,
   (iii) treating the lithium loaded sorbent to produce a mixture of a lithium rich solution and a regenerated sorbent, and
   (iv) separating the lithium rich solution and the regenerated sorbent, wherein the pH in step (i) is controlled to provide the lithium depleted solution at a pH of about 3 to 7.
2. A process for extracting lithium from an aqueous solution containing lithium, the process comprising:
   (i) contacting an aqueous solution containing lithium with a lithium sorbent to absorb the lithium to produce a mixture of a lithium loaded sorbent and lithium depleted solution,
   (ii) separating the lithium loaded sorbent and the lithium depleted solution,
   (iii) treating the lithium loaded sorbent to produce a mixture of a lithium rich solution and a regenerated sorbent, and
   (iv) separating the lithium rich solution and the regenerated sorbent, wherein the separating step (ii) and/or the separating step (iv) comprises the use of an ultrafiltration membrane or a nanofiltration membrane.
3. A process for extracting lithium from an aqueous solution containing lithium, the process comprising:
   (i) contacting an aqueous solution containing lithium with a lithium sorbent to absorb the lithium to produce a mixture of a lithium loaded sorbent and lithium depleted solution,
   (ii) separating the lithium loaded sorbent and the lithium depleted solution,
   (iii) treating the lithium loaded sorbent to produce a mixture of a lithium rich solution and a regenerated sorbent, and
   (iv) separating the lithium rich solution and the regenerated sorbent, wherein the pH in step (i) is controlled to provide the lithium depleted solution at a pH of about 3 to 7 and the separating step (ii) and/or the separating step (iv) comprises the use of an ultrafiltration membrane and/or a nanofiltration membrane.
4. A process for extracting lithium from an aqueous solution containing lithium, the process comprising:
   (i) contacting an aqueous solution containing lithium with a lithium sorbent to absorb the lithium to produce a mixture of a lithium loaded sorbent and lithium depleted solution,
   (ii) separating the lithium loaded sorbent and the lithium depleted solution,
   (iii) treating the lithium loaded sorbent with an acid to produce a mixture of a lithium rich solution and a regenerated sorbent, and
   (iv) separating the lithium rich solution and the regenerated sorbent, wherein the pH in step (i) is controlled to provide the lithium depleted solution at a pH of about 3 to 5.5.
5. The process of any one of items 1 to 4, wherein the lithium sorbent is a metal oxide-based ion exchange sorbent.
6. The process of item 5, wherein the metal oxide-based ion exchange sorbent is a hydrogen manganese oxide sorbent or hydrogen titanium oxide sorbent.
7. The process of item 5, wherein the metal oxide-based ion exchange sorbent is a hydrogen manganese oxide sorbent.
8. The process of any one of items 1 to 7, wherein the lithium sorbent is micronized.
9. The process of any one of items 1 to 8, wherein the lithium sorbent has an average particle size D₅₀ of less than about 100 μm.
10. The process of any one of items 1 to 9, wherein the lithium sorbent has an average particle size D₅₀ of less than about 50 μm, less than about 40 μm, less than about 30 μm, less than about 20 μm, less than about 10 μm, less than about 8 μm, less than about 6 μm, less than about 4 μm or less than about 2 μm.
11. The process of any one of items 1 to 10, wherein the lithium sorbent has a particle size distribution of about 100 to 0.01 μm.
12. The process of any one of items 1 to 11, wherein the lithium sorbent has a particle size distribution of about 50 to 0.01 μm, about 20 to 0.01 μm, about 10 to 0.01 μm, about 5 to 0.01 μm or about 2 to 0.1 μm.
13. The process of any one of items 1 to 12, wherein the lithium sorbent has a particle size distribution of about 100 to 0.1 μm or the lithium sorbent has a particle size distribution of about 50 to 0.1 μm, about 20 to 0.1 μm or about 10 to 0.1 μm.
14. I The process of any one of items 1 to 13, wherein the lithium sorbent has a density of about 1.8 to 5.0 g/cm³.
15. The process of any one of items 1 to 14, wherein a base is added to the aqueous solution containing lithium to maintain the pH between 3 to 7 when the lithium is being absorbed.
16. The process of any one of items 1 to 14, wherein the aqueous solution comprises a buffer to maintain the pH between 3 to 7 when the lithium is being absorbed.
17. The process of any one of items 1 to 16, wherein the pH of the aqueous solution containing lithium is maintained at an average pH of about 3 to 7 when the lithium is being absorbed.
18. The process of any one of items 1 to 17, wherein the pH of the aqueous solution containing lithium is maintained at an average pH of about 5 to 7 when the lithium is being absorbed.
19. The process of any one of items 1 to 18, wherein the pH of the aqueous solution containing lithium is maintained at an average pH of about 5 to 6 when the lithium is being absorbed.
20. The process of any one of items 1 to 17, wherein the pH of the aqueous solution containing lithium is maintained at an average pH of about 6 to 7 during step (i) and allowed to become more acidic at the end of step (i).
21. The process of any one of items 1 to 17, wherein the pH of the aqueous solution containing lithium is maintained at an average pH of about 6 to 7 during step (i) and allowed to reach a pH of about 5 at the end of step (i).
22. The process of any one of items 1 to 17, wherein the pH of the aqueous solution containing lithium is maintained at an average pH of about 6 to 7 during step (i) and acidified to a pH of about 5 at the end of step (i).
23. The process of item 15, wherein the base is added at a rate such that localized precipitation is reduced.
24. The process item 15, wherein the base is added at a rate such that the pH is maintained between 3 to 7.
25. The process of item 15, wherein the base is added at a rate such that localized precipitation substantially does not occur.
26. The process of item 15, wherein the base is added at a rate such that the pH does not exceed pH 7.
27. The process of item 15, wherein the base is added at a rate such that localized precipitation substantially does not occur.
28. The process of item 15, wherein the base is added at a rate such that the pH does not exceed pH 6.99.
29. The process of item 15, wherein the base is added at a rate such that localized precipitation substantially does not occur.
30. The process of item 15, wherein the base is added at a rate such that the pH does not exceed pH 5.5.
31. The process of any one of items 1 to 30, wherein a diluted base is added to the aqueous solution containing lithium such that localized precipitation is reduced.
32. The process of any one of items 1 to 30, wherein a diluted base is added to the aqueous solution containing lithium such that localized precipitation substantially does not occur.
33. The process of any one of items 1 to 14, wherein the pH in step (i) is controlled to provide the lithium depleted solution at a pH of about 3 to 5.5.
34. The process of any one of items 1 to 14, wherein the lithium depleted solution has a pH of about 3.0 to 6.9 once absorption is substantially completed.
35. The process of any one of items 1 to 14, wherein the lithium depleted solution has a pH of about 3.0 to 6.0 once absorption is substantially completed.
36. The process of any one of items 1 to 14, wherein the lithium depleted solution has a pH of about 3.0 to 5.8 once absorption is substantially completed or the lithium depleted solution has a pH of about 3.0 to 5.5 once absorption is substantially completed.
37. The process of any one of items 1 to 36, wherein the separating step (ii) and/or the separating step (iv) comprises filtering the mixture through an ultrafiltration membrane and/or a nanofiltration membrane.
38. The process of any one of items 1 to 36, wherein the separating step (ii) and/or the separating step (iv) comprises dewatering the mixture with an ultrafiltration membrane and/or a nanofiltration membrane.
39. The process of any one of items 1 to 36, wherein the separating step (ii) and the separating step (iv) comprises filtering the solution through an ultrafiltration membrane and/or a nanofiltration membrane.
40. The process of any one of items 1 to 36, wherein the separating step (ii) comprises filtering the solution through an ultrafiltration membrane and/or a nanofiltration membrane to separate the lithium loaded sorbent and the lithium depleted solution.
41. The process of any one of items 1 to 36, wherein the separating step (iv) comprises filtering the solution through an ultrafiltration membrane and/or a nanofiltration membrane to separate the lithium rich solution and the regenerated sorbent.
42. The process of any one of items 1 to 36, wherein the separating step (ii) and/or separating step (iv) comprises a dialysis step, wherein the sorbent is washed with water and filtered through an ultrafiltration membrane and/or a nanofiltration membrane to decrease the amount of a soluble impurity in the sorbent.
43. The process of any one of items 1 to 36, wherein the separating step (ii) and/or separating step (iv) comprises a dialysis step, wherein the sorbent is washed with water and filtered through an ultrafiltration membrane and/or a nanofiltration membrane to substantially decrease the amount of a soluble impurity in the sorbent.
44. The process of any one of items 1 to 36, wherein the separating step (ii) and separating step (iv) comprise a dialysis step, wherein the sorbent is washed with water and filtered through an ultrafiltration membrane and/or a nanofiltration membrane to decrease the amount of a soluble impurity in the sorbent.
45. The process of any one of items 1 to 36, wherein the separating step (ii) comprises a dialysis step, wherein the lithium loaded sorbent is washed with water and filtered through an ultrafiltration membrane and/or a nanofiltration membrane to decrease the amount of a soluble impurity in the sorbent.
46. The process of any one of items 1 to 36, wherein the separating step (iv) comprises a dialysis step, wherein the regenerated sorbent is washed with water and filtered through an ultrafiltration membrane and/or a nanofiltration membrane to decrease the amount of a soluble impurity in the sorbent.
47. The process of any one of items 1 to 36, wherein the separating step (ii) and/or separating step (iv) comprises a dialysis step, wherein the sorbent is washed with water and cross-flow filtered through an ultrafiltration membrane and/or nanofiltration membrane to decrease the amount of a soluble impurity in the sorbent.
48. The process of any one of items 1 to 36, wherein the separating step (ii) and/or separating step (iv) comprises a dialysis step, wherein the sorbent is washed with water and cross-flow filtered through an ultrafiltration membrane and/or a nanofiltration membrane to substantially decrease the amount of a soluble impurity in the sorbent.
49. The process of any one of items 1 to 36, wherein the separating step (ii) and separating step (iv) comprise a dialysis step, wherein the sorbent is washed with water and cross-flow filtered through an ultrafiltration membrane and/or a nanofiltration membrane to decrease the amount of a soluble impurity in the sorbent.
50. The process of any one of items 1 to 36, wherein the separating step (ii) comprises a dialysis step, wherein the lithium loaded sorbent is washed with water and cross-flow filtered through an ultrafiltration membrane and/or a nanofiltration membrane to decrease the amount of a soluble impurity in the sorbent.
51. The process of any one of items 1 to 36, wherein the separating step (iv) comprises a dialysis step, wherein the regenerated sorbent is washed with water and cross-flow filtered through an ultrafiltration membrane and/or a nanofiltration membrane to decrease the amount of a soluble impurity in the sorbent.
52. The process of any one of items 42 to 51, wherein the water is deionized water.
53. The process of any one of items 42 to 52, wherein the dialysis step reduces the conductivity of a filtrate.
54. The process of item 53, wherein the conductivity of the filtrate after the dialysis step is less than about 100 mS/cm, less than about 50 mS/cm, less than about 40 mS/cm, less than about 30 mS/cm, less than about 20 mS/cm, less than about 10 mS/cm, less than about 5 mS/cm, less than about 1 mS/cm, less than about 0.5 mS/cm, less than about 0.5 μS/cm, less than about 0.1 μS/cm or less than about 0.05 μS/cm.
55. The process of any one of items 1 to 36, wherein the separating step (ii) and/or separating step (iv) comprises cross-flow filtration using an ultrafiltration membrane and/or a nanofiltration membrane.
56. The process of any one of items 1 to 36, wherein the separating step (ii) and/or separating step (iv) comprises inside-out filtration using an ultrafiltration membrane and/or a nanofiltration membrane.
57. The process of any one of items 1 to 36, wherein the separating step (ii) and/or separating step (iv) comprises outside-in filtration using an ultrafiltration membrane and/or a nanofiltration membrane.
58. The process of any one of items 1 to 36, wherein the separating step (ii) and/or separating step (iv) comprises inside-out cross-flow filtration using an ultrafiltration membrane and/or a nanofiltration membrane.
59. The process of any one of items 1 to 36, wherein the separating step (ii) and/or separating step (iv) comprises outside-in cross-flow filtration using an ultrafiltration membrane and/or a nanofiltration membrane.
60. The process of any one of items 1 to 59, wherein the ultrafiltration membrane and/or nanofiltration membrane is a hollow fiber or spiral wound membrane.
61. The process of any one of items 1 to 60, wherein the ultrafiltration membrane and/or nanofiltration membrane is part of a crossflow system.
62. The process of any one of items 1 to 61, wherein the ultrafiltration membrane and/or nanofiltration membrane is a PES or PVDF hollow fibre membrane.
63. The process of item 62, wherein the nanofiltration membrane is a PVDF outside-in hollow fibre membrane.
64. The process of any one of items 1 to 63, wherein step (ii) and/or step (iv) is performed with a back pressure ranging from about 0 to 3 bar, about 0 to 2 bar, about 0 to 1 bar or about 0.1 to 0.8 bar (e.g., when using a 4 m² membrane).
65. The process of any one of items 1 to 64, wherein a back washing process is performed to remove solids built-up on a surface of the ultrafiltration membrane and/or nanofiltration membrane.
66. The process of any one of items 1 to 65, wherein step (ii) and/or step (iv) is performed with a filtration trans-membrane pressure (TMP) ranging from about 0.2 to 3.5 bar with suspended solids varying from 10 wt % to about 60 wt % (for example when using a 4 m² membrane with a rated maximum filtration TMP of about 3 bar).
67. The process of any one of items 1 to 66, wherein step (ii) and/or step (iv) is performed with a filtration differential pressure ranging from about 0.2 to 1.5 bar over each membrane module.
68. The process of item 67, wherein there are multiple membrane modules.
69. The process of any one of items 1 to 68, wherein during step (ii) and/or (iv) a backflush is performed with trans-membrane pressure ranging from 0.2 to 3.5 bar.
70. The process of any one of items 1 to 69, wherein the backflush solution comprises water.
71. The process of any one of items 1 to 70, wherein the backflush solution comprises a filtrate produced during step (ii) and/or (iv).
72. The process of any one of items 1 to 70, wherein the backflush comprises air.
73. The process of any one of items 1 to 72, wherein the ultrafiltration membrane and/or nanofiltration membrane comprises a feed spacer.
74. The process of any one of items 1 to 73, wherein the ultrafiltration membrane and/or nanofiltration membrane is a spiral wound membrane and comprises a feed spacer.
75. The process of claim 73 or 74, wherein the feed spacer is about 0.5 to 2 mm.
76. The process of any one of items 1 to 75, wherein the ultrafiltration membrane and/or nanofiltration membrane comprises several hollow fibers.
77. The process of claim 76, wherein the hollow fiber bore size is 0.4 to 1.8 μm.
78. The process of any one of items 1 to 78, wherein step (ii) and/or step (iv) is performed at a temperature ranging from 0 to 100° C., about 0 to 80° C., about 0 to 60° C. or about 0 to 40° C.
79. The process of any one of items 1 to 78, wherein the mixture of the lithium depleted solution and lithium loaded sorbent in step (i) has a concentration of up to about 80 wt % solids or about 60 wt % solids.
80. The process of any one of items 1 to 79, wherein the mixture of the lithium depleted solution and lithium loaded sorbent in step (i) has a concentration of about 1 to 55 wt % solids or about 10 to 55 wt % solids.
81. The process of any one of items 1 to 79, wherein the mixture of the lithium rich solution and regenerated sorbent in step (iv) has a concentration of up to about 80 wt % solids or about 60 wt % solids or the lithium rich solution and regenerated sorbent in step (iv) has a concentration of about 1 to 55 wt % solids or about 10 to 55 wt % solids.
82. The process of any one of items 1 to 81, wherein the amount of lithium sorbent contacted with the aqueous solution containing lithium is in excess dose to the amount of lithium in the aqueous solution
83. The process of any one of items 1 to 82, wherein the amount of the lithium sorbent is about over 1 to 3 times the dose to the amount of lithium in the aqueous solution.
84. The process of any one of items 1 to 83, wherein the aqueous solution containing lithium is agitated during contacting step (i).
85. The process of any one of items 1 to 84, wherein the lithium sorbent is suspended in the aqueous solution.
86. The process of any one of items 1 to 84, wherein the aqueous solution containing lithium is agitated to suspend the sorbent particles during contact with the lithium sorbent.
87. The process of any one of items 1 to 84, wherein the aqueous solution containing lithium is stirred vigorously to suspend the sorbent particles when contacted with the lithium sorbent.
88. The process of any one of items 1 to 87, wherein the aqueous solution containing lithium is at a temperature of about 0 to 100° C. when contacted with the lithium sorbent.
89. The process of any one of items 1 to 88, wherein the aqueous solution containing lithium is at a temperature of about 0 to less than 100° C. when contacted with the lithium sorbent.
90. The process of any one of items 1 to 89, wherein the aqueous solution containing lithium is at a temperature of about 10 to 90° C. when contacted with the lithium sorbent.
91. The process of any one of items 1 to 90, wherein the aqueous solution containing lithium is at a temperature of about 20 to 90° C. when contacted with the lithium sorbent.
92. The process of any one of items 1 to 91, wherein the aqueous solution containing lithium is at a temperature of about 30 to 90° C. when contacted with the lithium sorbent.
93. The process of any one of items 1 to 92, wherein the aqueous solution containing lithium is at a temperature of about 40 to 90° C. when contacted with the lithium sorbent.
94. The process of any one of items 1 to 93, wherein the aqueous solution containing lithium in step (i) is heated.
95. The process of any one of items 1 to 93, wherein the aqueous solution containing lithium in step (i) is not heated.
96. The process of any one of items 1 to 95, wherein the aqueous solution is contacted with the sorbent for about 20 seconds to 12 hours or the aqueous solution is contacted with the sorbent for about 30 seconds to 12 hours or the aqueous solution is contacted with the sorbent for about 1 minute to 12 hours or the aqueous solution is contacted with the sorbent for about 1 minute to 10 hours or the aqueous solution is contacted with the sorbent for about 1 minute to 8 hours or the aqueous solution is contacted with the sorbent for about 1 minute to 6 hours or the aqueous solution is contacted with the sorbent for about 1 minute to 5 hours or the aqueous solution is contacted with the sorbent for about 1 minute to 4 hours; more preferably the aqueous solution is contacted with the sorbent for about 2 minutes to 4 hours.
97. The process of any one of items 1 to 96, wherein the aqueous solution is contacted with the sorbent for about 5 minutes to 3 hours.
98. The process of any one of items 1 to 79, wherein the aqueous solution is contacted with a hydrogen manganese oxide sorbent for about 20 seconds to 12 hours or the aqueous solution is contacted with a hydrogen manganese oxide sorbent for about 30 seconds to 12 hours or the aqueous solution is contacted with a hydrogen manganese oxide sorbent for about 1 minute to 12 hours or the aqueous solution is contacted with a hydrogen manganese oxide sorbent for about 1 minute to 10 hours or the aqueous solution is contacted with a hydrogen manganese oxide sorbent for about 1 minute to 8 hours or the aqueous solution is contacted with a hydrogen manganese oxide sorbent for about 1 minute to 6 hours or the aqueous solution is contacted with a hydrogen manganese oxide sorbent for about 1 minute to 5 hours or the aqueous solution is contacted with a hydrogen manganese oxide sorbent for about 1 minute to 4 hours or the aqueous solution is contacted with a hydrogen manganese oxide sorbent for about 2 minutes to 4 hours or the aqueous solution is contacted with a hydrogen manganese oxide sorbent for about 5 minutes to 3 hours.
99. The process of any one of items 1 to 98, wherein the sorbent is brought into contact with the aqueous solution containing lithium at about 1 to 700 g/L; or, about 1 to 500 g/L; or, about 1 to 200 g/L; or, about 1 to 100 g/L; or, about 1 to 50 g/L.
100. The process of any one of items 1 to 79, wherein the ratio of one or more impurity/Li in the lithium rich solution is decreased relative to an equivalent process in which the lithium depleted solution is provided at a pH above 6 or the ratio of one or more impurity/Li in the lithium rich solution is decreased relative to an equivalent process in which the lithium depleted solution is provided at a pH above 7 or the ratio of one or more impurity/Li in the lithium rich solution is decreased relative to an equivalent process in which the lithium depleted solution is provided at a pH above 8 or the ratio of one or more impurity/Li in the lithium rich solution is decreased relative to an equivalent process in which the lithium depleted solution is provided at a pH above 9 or the ratio of one or more impurity/Li in the lithium rich solution is decreased relative to an equivalent process in which the lithium depleted solution is provided at a pH above 10.
101. The process of any one of items 1 to 99, wherein the ratio of an impurity/Li in the lithium rich solution is less than about 50 or the ratio of an impurity/Li in the lithium rich solution is less than about 20 or the ratio of an impurity/Li in the lithium rich solution is less than about 10 or the ratio of an impurity/Li in the lithium rich solution is less than about 5 or the ratio of an impurity/Li in the lithium rich solution is less than about 2 or the ratio of an impurity/Li in the lithium rich solution is less than about 1 or the ratio of an impurity/Li in the lithium rich solution is less than about 0.8 or the ratio of an impurity/Li in the lithium rich solution is less than about 0.5 or the ratio of an impurity/Li in the lithium rich solution is less than about 0.1 or the ratio of an impurity/Li in the lithium rich solution is less than about 0.05 or the ratio of an impurity/Li in the lithium rich solution is less than about 0.01.
102. The process of any one of items 1 to 101, wherein the impurity is a multi-valent ion or the impurity comprises B, Ba, Ca, Mg, Na, Sr and/or Zn, amongst others.
103. The process of any one of items 1 to 102, wherein the ratio of Ca/Li in the lithium rich solution is decreased relative to a process in which the lithium depleted solution is provided at a pH above 7 or the ratio of Ca/Li in the lithium rich solution is decreased relative to a process in which the lithium depleted solution is provided at a pH above 8 or the ratio of Ca/Li in the lithium rich solution is decreased relative to a process in which the lithium depleted solution is provided at a pH above 9 or the ratio of Ca/Li in the lithium rich solution is decreased relative to a process in which the lithium depleted solution is provided at a pH above 10.
104. The process of any one of items 1 to 102, wherein the ratio of Ca/Li in the lithium rich solution is less than about 50 or the ratio of Ca/Li in the lithium rich solution is less than about 20 or the ratio of Ca/Li in the lithium rich solution is less than about 10 or the ratio of Ca/Li in the lithium rich solution is less than about 5 or the ratio of Ca/Li in the lithium rich solution is less than about 5 or the ratio of Ca/Li in the lithium rich solution is less than about 2 or the ratio of Ca/Li in the lithium rich solution is less than about 1 or the ratio of Ca/Li in the lithium rich solution is less than about 0.5 or the ratio of Ca/Li in the lithium rich solution is less than about 0.01.
105. The process of any one of items 1 to 104, wherein the ratio of Mg/Li in the lithium rich solution is decreased relative to an equivalent process in which the lithium depleted solution is provided at a pH above 7 or the ratio of Mg/Li in the lithium rich solution is decreased relative to an equivalent process in which the lithium depleted solution is provided at a pH above 8 or the ratio of Mg/Li in the lithium rich solution is decreased relative to an equivalent process in which the lithium depleted solution is provided at a pH above 9 or the ratio of Mg/Li in the lithium rich solution is decreased relative to an equivalent process in which the lithium depleted solution is provided at a pH above 10 or the ratio of Mg/Li in the lithium rich solution is less than about 50 or the ratio of Mg/Li in the lithium rich solution is less than about 20 or the ratio of Mg/Li in the lithium rich solution is less than about 10 or the ratio of Mg/Li in the lithium rich solution is less than about 5 or the ratio of Mg/Li in the lithium rich solution is less than about 5 or the ratio of Mg/Li in the lithium rich solution is less than about 2 or the ratio of Mg/Li in the lithium rich solution is less than about 1 or the ratio of Mg/Li in the lithium rich solution is less than about 0.8 or the ratio of Mg/Li in the lithium rich solution is less than about 0.5 or the ratio of Mg/Li in the lithium rich solution is less than about 0.2 or the ratio of Mg/Li in the lithium rich solution is less than about 0.1 or the ratio of Mg/Li in the lithium rich solution is less than about 0.01.
106. The process of any one of items 1 to 105, wherein the ratio of Na/Li in the lithium rich solution is decreased relative to an equivalent process in which the lithium depleted solution is provided at a pH above 7 or the ratio of Na/Li in the lithium rich solution is decreased relative to an equivalent process in which the lithium depleted solution is provided at a pH above 8 or the ratio of Na/Li in the lithium rich solution is decreased relative to an equivalent process in which the lithium depleted solution is provided at a pH above 9 or the ratio of Na/Li in the lithium rich solution is decreased relative to an equivalent process in which the lithium depleted solution is provided at a pH above 10.
107. The process of any one of items 1 to 106, wherein the ratio of Na/Li in the lithium rich solution is less than about 50 or the ratio of Na/Li in the lithium rich solution is less than about 20 or the ratio of Na/Li in the lithium rich solution is less than about 10 or the ratio of Na/Li in the lithium rich solution is less than about 5 or the ratio of Na/Li in the lithium rich solution is less than about 5 or the ratio of Na/Li in the lithium rich solution is less than about 2.
108. The process of any one of items 1 to 107, wherein the amount of Mn in the lithium rich solution is decreased relative to an equivalent process in which an aqueous solution containing lithium is maintained at an average pH above 7 when the lithium is being absorbed or the amount of Mn in the lithium rich solution is decreased relative to an equivalent process in which an aqueous solution containing lithium is maintained at an average pH above 8 when the lithium is being absorbed or the amount of Mn in the lithium rich solution is decreased relative to an equivalent process in which an aqueous solution containing lithium is maintained at an average pH above 9 when the lithium is being absorbed or the amount of Mn in the lithium rich solution is decreased relative to an equivalent process in which an aqueous solution containing lithium is maintained at an average pH above 10 when the lithium is being absorbed.
109. The process of any one of items 1 to 108, wherein the amount of Mn in the lithium rich solution is decreased relative to an equivalent process in which an aqueous solution containing lithium reaches a maximum pH above 7 when the lithium is being absorbed or the amount of Mn in the lithium rich solution is decreased relative to an equivalent process in which an aqueous solution containing lithium reaches a maximum pH above 8 when the lithium is being absorbed or the amount of Mn in the lithium rich solution is decreased relative to an equivalent process in which an aqueous solution containing lithium reaches a maximum pH above 9 when the lithium is being absorbed or the amount of Mn in the lithium rich solution is decreased relative to an equivalent process in which an aqueous solution containing lithium reaches a maximum pH above 10 when the lithium is being absorbed.
110. The process of any one of items 1 to 109, wherein water is added to the separated lithium loaded sorbent.
111. The process of item 110, wherein the water is added to the separated lithium loaded sorbent to dilute the mixture to about 1 to 1000 g/L, about 200 to 900 g/L, about 400 to 900 g/L, about 600 to 900 g/L or about 700 g/L of the sorbent.
112. The process of any one of items 1 to 111, wherein the treatment in step (iii) comprises contacting the lithium loaded sorbent with an acid to produce a mixture of a lithium rich solution and a regenerated sorbent.
113. The process of item 112, wherein the acid in step (iii) is selected from one or more mineral acids and/or organic acids.
114. The process of item 112, wherein the acid in step (iii) is selected from one or more of HCl, H₂SO₄, HBr, HI and phosphoric acid.
115. The process of any one of items 112 to 114, wherein the acid is contacted with the lithium loaded sorbent for about 5 minutes to 3 hours.
116. The process of any one of items 112 to 115, wherein the acid in step (iii) substantially does not dissolve the sorbent.
117. The process of any one of items 112 to 116, wherein the acid in step (iii) is a concentrated or dilute acid.
118. The process of any one of items 1 to 111, wherein the treating step (iii) comprises contacting the lithium loaded sorbent with an oxidizing agent to produce a mixture of a lithium rich solution and a regenerated sorbent.
119. The process of any one of items 1 to 118, wherein the process further comprises washing the lithium loaded sorbent; optionally, washing the lithium loaded sorbent with water.
120. The process of any one of items 1 to 119, wherein step (iii) is performed at a temperature of about 0 to 100° C., optionally about 10 to 100° C., about 20 to 100° C., about 30 to 100° C. or about 40 to 100° C.
121. The process of any one of items 1 to 120, wherein the regenerated sorbent is reused in step (i) of the process.
122. The process of any one of items 6, 7 and 98, wherein the hydrogen manganese oxide sorbent is produced by leaching the lithium from a lithium manganese oxide with an acid.
123. The process of any one of items 1 to 122, wherein the aqueous solution containing lithium is selected from a geothermal brine, salar brine, formation waters, sea water, concentrates from processing seawater, a waste stream from a lithium processing facility, a waste stream from a battery recycling plants, oil well brines, other ground water.
124. The process of any one of items 1 to 122, wherein the process further comprises milling the lithium sorbent.
125. The process of item 124, wherein lithium sorbent is milled using a ball mill, a ring mill, a bead mill and/or any other device able to reduce particle size.
126. The process of any one of items 1 to 125, wherein the regenerated sorbent is recycled in the process.
127. The process of any one of items 1 to 122, wherein the lithium sorbent shows an initial particle size of 100 μm or less.
128. The process of item 126, wherein the recycled sorbent shows a reduced particle size with the number of cycles performed that is 10 μm or less, 1 μm or less, or 1 to 0.1 μm.
129. The process of any one of items 1 to 128, wherein one or more of steps (i)-(iv) are performed in a batch process.
130. The process of any one of items 1 to 128, wherein all of steps (i)-(iv) are performed in a batch process.
131. The process of any one of items 1 to 128, wherein one or more of steps (i)-(iv) are performed in a continuous process.
132. The process of any one of items 1 to 128, wherein all of steps (i)-(iv) are performed in a continuous process.
133. A system for extracting lithium from an aqueous solution containing lithium, the system comprising:
   (i) a first container for contacting an aqueous solution containing lithium with a lithium sorbent to absorb the lithium to produce a mixture of a lithium loaded sorbent and lithium depleted solution,
   (ii) a first separating device to separate the lithium loaded sorbent and the lithium depleted solution,
   (iii) means for treating the lithium loaded sorbent to produce a mixture of a lithium rich solution and a regenerated sorbent, and
   (iv) a second separating device to separate the lithium rich solution and the regenerated sorbent wherein the first separating device and/or the second separating device comprises an ultrafiltration membrane and/or a nanofiltration membrane.
134. A system for extracting lithium from an aqueous solution containing lithium, the system comprising,
   (i) a first container for contacting an aqueous solution containing lithium with a lithium sorbent to absorb the lithium to produce a lithium loaded sorbent and lithium depleted solution,
   (ii) pH control to control the pH of the aqueous solution to provide the lithium depleted solution at a pH of about 3 to 7,
   (iii) a pH monitor to measure the pH of the aqueous solution containing lithium and/or the lithium depleted solution,
   (iv) a first separating device to separate the lithium loaded sorbent and the lithium depleted solution,
   (v) means for treating the lithium loaded sorbent to produce a lithium rich solution and a regenerated sorbent, and
   (vi) a second separating device to separate the lithium rich solution and the regenerated sorbent.
135. A system for extracting lithium from an aqueous solution containing lithium, the system comprising,
   (i) a first container for contacting an aqueous solution containing lithium with a lithium sorbent to absorb the lithium to produce a mixture of a lithium loaded sorbent and lithium depleted solution,
   (ii) pH control to control the pH of the aqueous solution to provide the lithium depleted solution at a pH of about 3 to 7,
   (iii) a pH monitor to measure the pH of the aqueous solution containing lithium and/or the lithium depleted solution,
   (iv) a first separating device to separate the lithium loaded sorbent and the lithium depleted solution,
   (v) means for treating the lithium loaded sorbent to produce a mixture of a lithium rich solution and a regenerated sorbent, and
   (vi) a second separating device to separate the lithium rich solution and the regenerated sorbent.
   wherein the first separating device and/or the second separating device comprises an ultrafiltration membrane and/or a nanofiltration membrane.
136. The system of any one of items 133 to 135, wherein the ultrafiltration membrane and/or nanofiltration membrane is a hollow fiber or spiral wound membrane.
137. The system of any one of items 133 to 135, wherein the ultrafiltration membrane and/or nanofiltration membrane is part of a crossflow system.
138. The system of any one of items 133 to 135, wherein the ultrafiltration membrane and/or nanofiltration membrane is a PES or PVDF hollow fibre membrane.
139. The system of item 138, wherein the nanofiltration membrane is a PVDF outside-in hollow fibre membrane.
140. The system of any one of items 133 to 135, wherein the ultrafiltration membrane and/or nanofiltration membrane comprises a feed spacer
141. The system of any one of items 133 to 135, wherein the ultrafiltration membrane and/or nanofiltration membrane is a spiral wound membrane and comprises a feed spacer
142. The system of item 140 or 141, wherein the feed spacer is about 0.5 to 2 mm.
143. The system of any one of items 133 to 135, wherein the ultrafiltration membrane and/or nanofiltration membrane comprises several hollow fibers
144. The system of item 143, wherein the hollow fiber bore size is 0.4 to 1.8 μm.
145. The system of any one of items 133 to 144, wherein the means for treating the lithium loaded sorbent in (iii) is a source of acid
146. The system of item 145, wherein the source of acid is selected from one or more mineral acids and/or organic acids
147. The system of item 146, wherein the source of acid is selected from one or more of HCl, H₂SO₄, HBr, HI and phosphoric acid.

1. A process for extracting lithium from an aqueous solution containing lithium, the process comprising:
(i) contacting an aqueous solution containing lithium with a lithium sorbent to absorb the lithium to produce a mixture of a lithium loaded sorbent and lithium depleted solution,
(ii) separating the lithium loaded sorbent and the lithium depleted solution,
(iii) treating the lithium loaded sorbent to produce a mixture of a lithium rich solution and a regenerated sorbent, and
(iv) separating the lithium rich solution and the regenerated sorbent,
wherein the pH in step (i) is controlled to provide the lithium depleted solution at a pH of about 3 to 7 and the separating step (ii) and/or the separating step (iv) comprises the use of an ultrafiltration membrane and/or a nanofiltration membrane.

2-4. (canceled)

5. The process of claim 1, wherein the lithium sorbent is a metal oxide-based ion exchange sorbent, and wherein the metal oxide-based ion exchange sorbent is a hydrogen manganese oxide sorbent or hydrogen titanium oxide sorbent.

6-7. (canceled)

8. The process of claim 1, wherein the lithium sorbent is micronized.

9. The process of claim 1, wherein the lithium sorbent has an average particle size D₅₀ of less than about 100 μm.

10-14. (canceled)

15. The process of claim 1, wherein a base is added to the aqueous solution containing lithium to maintain the pH between 3 to 7 when the lithium is being absorbed, or wherein the aqueous solution comprises a buffer to maintain the pH between 3 to 7 when the lithium is being absorbed.

16. (canceled)

17. The process of claim 1, wherein the pH of the aqueous solution containing lithium is maintained at an average pH of about 3 to 7, about 5 to 7, or about 5 to 6 when the lithium is being absorbed.

18-19. (canceled)

20. The process of claim 1, wherein the pH of the aqueous solution containing lithium is maintained at an average pH of about 6 to 7 during step (i) and allowed to become more acidic at the end of step (i), or wherein the pH of the aqueous solution containing lithium is maintained at an average pH of about 6 to 7 during step (i) and allowed to reach a pH of about 5 at the end of step (i), or wherein the pH of the aqueous solution containing lithium is maintained at an average pH of about 6 to 7 during step (i) and acidified to a pH of about 5 at the end of step (i).

21-25. (canceled)

26. The process of claim 15, wherein the base is added at a rate such that the pH does not exceed pH 7 and/or localized precipitation is reduced.

27-32. (canceled)

33. The process of claim 1, wherein the pH in step (i) is controlled to provide the lithium depleted solution at a pH of about 3 to 5.5.

34. The process of claim 1, wherein the lithium depleted solution has a pH of about 3.0 to 6.9, or about 3.0 to 6.0, or about 3.0 to 5.8, or about 3.0 to 5.5 once absorption is substantially completed.

35-36. (canceled)

37. The process of claim 1, wherein the separating step (ii) and/or the separating step (iv) comprises cross-flow filtration using an ultrafiltration membrane and/or a nanofiltration membrane.

38-41. (canceled)

42. The process of claim 1, wherein the separating step (ii) and/or separating step (iv) comprises a dialysis step, wherein the sorbent is washed with water and filtered through an ultrafiltration membrane and/or a nanofiltration membrane to decrease the amount of a soluble impurity in the sorbent.

43. (canceled)

44. The process of claim 1, wherein the separating step (ii) and/or separating step (iv) comprises a dialysis step, wherein the sorbent is washed with water and cross-flow filtered through an ultrafiltration membrane and/or a nanofiltration membrane to decrease the amount of a soluble impurity in the sorbent.

45-78. (canceled)

79. The process of claim 1, wherein the mixture of the lithium depleted solution and lithium loaded sorbent in step (i) has a concentration of up to about 80 wt % solids or about 30 wt % solids.

80-100. (canceled)

101. The process of claim 1, wherein the ratio of an impurity/Li in the lithium rich solution is less than about 50 or the ratio of an impurity/Li in the lithium rich solution is less than about 20 or the ratio of an impurity/Li in the lithium rich solution is less than about 10 or the ratio of an impurity/Li in the lithium rich solution is less than about 5 or the ratio of an impurity/Li in the lithium rich solution is less than about 2 or the ratio of an impurity/Li in the lithium rich solution is less than about 1 or the ratio of an impurity/Li in the lithium rich solution is less than about 0.8 or the ratio of an impurity/Li in the lithium rich solution is less than about 0.5 or the ratio of an impurity/Li in the lithium rich solution is less than about 0.1 or the ratio of an impurity/Li in the lithium rich solution is less than about 0.05 or the ratio of an impurity/Li in the lithium rich solution is less than about 0.01.

102-103. (canceled)

104. The process of claim 1, wherein the ratio of Ca/Li in the lithium rich solution is less than about 50 or the ratio of Ca/Li in the lithium rich solution is less than about 20 or the ratio of Ca/Li in the lithium rich solution is less than about 10 or the ratio of Ca/Li in the lithium rich solution is less than about 5 or the ratio of Ca/Li in the lithium rich solution is less than about 2 or the ratio of Ca/Li in the lithium rich solution is less than about 1 or the ratio of Ca/Li in the lithium rich solution is less than about 0.5 or the ratio of Ca/Li in the lithium rich solution is less than about 0.01.

105-108. (canceled)

109. The process of claim 1, wherein the amount of Mn in the lithium rich solution is decreased relative to an equivalent process in which an aqueous solution containing lithium reaches a maximum pH above 7 when the lithium is being absorbed or the amount of Mn in the lithium rich solution is decreased relative to an equivalent process in which an aqueous solution containing lithium reaches a maximum pH above 8 when the lithium is being absorbed or the amount of Mn in the lithium rich solution is decreased relative to an equivalent process in which an aqueous solution containing lithium reaches a maximum pH above 9 when the lithium is being absorbed or the amount of Mn in the lithium rich solution is decreased relative to an equivalent process in which an aqueous solution containing lithium reaches a maximum pH above 10 when the lithium is being absorbed.

110-122. (canceled)

123. The process of claim 1, wherein the aqueous solution containing lithium is selected from a geothermal brine, salar brine, formation waters, sea water, concentrates from processing seawater, a waste stream from a lithium processing facility, a waste stream from a battery recycling plants, oil well brines, other ground water.

124-128. (canceled)

129. The process of claim 1, wherein one or more of steps (i)-(iv) are performed in a batch process or all of steps (i)-(iv) are performed in a batch process.

130. (canceled)

131. The process of claim 1, wherein one or more of steps (i)-(iv) are performed in a continuous process or wherein all of steps (i)-(iv) are performed in a continuous process.

132-147. (canceled)
